(19) United States
(12) Patent Application Publication
(10) Pub. No.: US 2026/0029302 A1
(43) Pub. Date: Jan. 29, 2026

(54) INSPECTION APPARATUS AND INSPECTION METHOD OF LIGHT EMITTING ELEMENT

(71) Applicant: LG Display Co., Ltd., Seoul (KR)

(72) Inventor: Seok Jun Jin, Gyeonggi-do (KR)

(21) Appl. No.: 19/195,273

(22) Filed: Apr. 30, 2025

(30) Foreign Application Priority Data
Jul. 24, 2024 (KR) 10-2024-0097585

(51) Int. Cl. G01M 11/02; G01N 21/88

(52) U.S. Cl. CPC G01M 11/0257; G01N 21/8851; G01N 2021/8864

(57) ABSTRACT

An inspection apparatus may include a collection part configured to acquire, according to a plurality of predetermined driving options, an image of first light emitting elements and second light emitting elements arranged in sub-pixels in a display panel, and a control part configured to calculate a number of defects for each driving option based on the acquired image, to compare the calculated number of defects for each driving option with a predetermined threshold value, and to determine whether the display panel is a usable normal panel based on a comparison result.

### CROSS-REFERENCE TO RELATED APPLICATION

Pursuant to 35 U.S.C. § 119 (a), this application claims the benefit of an earlier filing date and right of priority to Korean Patent Application No. 10-2024-0097585, filed on Jul. 24, 2024, the disclosure of which is incorporated herein by reference in its entirety.

### TECHNICAL FIELD

The present disclosure relates to an inspection apparatus and an inspection method of light emitting elements.

### BACKGROUND

Display devices are being applied to various electronic devices such as TVs, mobile phones, laptops, and tablets.

Display devices include organic light-emitting display (OLED) devices, which are self-emissive, liquid crystal display (LCD) devices, which require a separate light source, and the like.

In recent years, display devices including light-emitting diodes (LEDs) have been gaining attention as next-generation display devices. Since LEDs are formed of inorganic materials rather than organic materials, the display devices including LEDs have a fast lighting speed and high luminous efficiency, and can display high-brightness images compared to liquid crystal display devices and organic light-emitting display devices.

### SUMMARY

An inspection apparatus according to an implementation of the present disclosure may include a collection part configured to acquire, according to a plurality of predetermined driving options, an image of first light emitting elements and second light emitting elements arranged in sub-pixels in a display panel; and a control part configured to calculate a number of defects for each driving option based on the acquired image, to compare the calculated number of defects for each driving option with a predetermined threshold value, and to determine whether the display panel is a usable normal panel based on a comparison result.

An inspection method according to an implementation of the present disclosure may include calculating a number of defects for each driving option by driving, according to a plurality of predetermined driving options, first light emitting elements and second light emitting elements arranged in sub-pixels in a display panel; and determining whether the display panel is a usable normal panel by comparing a calculated number of defects for each driving option with a predetermined threshold value.

According to the present disclosure, by calculating the number of defects for each predetermined option of sub-pixels, and determining whether to use the display panel based on the minimum number of defects among the calculated options, it is possible to improve the process yield and reliability of the display device by reducing the discarded display panels.

According to the present disclosure, the process yield is improved, so process optimization may be possible.

The effects of the present disclosure are not limited to the effects mentioned above, and other effects not mentioned will be apparent to one having ordinary skill in the art to which the technical ideas of the present disclosure belong from the following description.

### BRIEF DESCRIPTION OF THE DRAWINGS

The above and other objects, features, and advantages of the present disclosure will become more apparent to those of ordinary skill in the art by describing examples of implementations thereof in detail with reference to the attached drawings, in which:

FIG. 1 is a diagram illustrating an inspection apparatus of light emitting elements according to an implementation of the present disclosure;

FIG. 2 is a diagram for explaining the driving principle of primary and redundancy light emitting elements;

FIG. 3 is a diagram illustrating an inspection method of light emitting elements according to an implementation of the present disclosure;

FIGS. 4, 5A to 5D, and 6A to 6C are diagrams for explaining the inspection method shown in FIG. 2;

FIG. 7 is an exploded perspective view illustrating a display device according to an implementation of the present disclosure;

FIG. 8 is a plan view illustrating a display device according to an implementation of the present disclosure;

FIG. 9 is an enlarged view illustrating a display device according to an implementation of the present disclosure;

FIGS. 10 to 12 are plan views illustrating a display device according to an implementation of the present disclosure.

FIG. 13 is a cross-sectional view taken along line C-C′ of FIG. 9;

FIGS. 14A to 14D are diagrams for showing the driving state of light emitting elements according to driving options of an implementation;

FIGS. 15A to 15D are diagrams for confirming the application of driving options according to an implementation; and

FIGS. 16 to 19 are diagrams illustrating devices to which the display device according to implementations of the present disclosure is applied.

### DETAILED DESCRIPTION

A display device including light emitting elements made of an inorganic material has a problem of low yield of the light emitting elements.

An objective of the present disclosure according to an implementation is to provide an inspection apparatus and an inspection method of light emitting elements with improved yield and reliability.

Objectives according to implementations of the present disclosure are not limited to the above-described objectives, and other objectives that are not described herein will be apparently understood by those skilled in the art from the following description.

Advantages and features of the present disclosure and a method of achieving the same should become clear with implementations described in detail below with reference to the accompanying drawings. However, the present disclosure is not limited to the implementations described below and may be implemented with a variety of different modifications. The implementations are merely provided to allow those skilled in the art to completely understand the scope of the present disclosure.

The shapes, dimensions, ratios, angles, numbers, and the like disclosed in the drawings for describing the implementations of the present disclosure are merely illustrative and are not limited to matters shown in the present disclosure. Like reference numerals refer to like elements throughout the disclosure. Further, in describing the present disclosure, detailed descriptions of well-known technologies will be omitted when it is determined that they may unnecessarily obscure the gist of the present disclosure. Terms such as “including,” “having,” and “composed of” used herein are intended to allow other elements to be added unless the terms are used with the term “only.” Any references to the singular may include the plural unless expressly stated otherwise.

Components are interpreted as including an ordinary error range even if no such margin is explicitly stated.

In the case of a description of a positional relationship, for example, in the case in which a position relationship between two portions is described with the terms “on,” “above,” “under,” “next to,” or the like, one or more portions may be interposed therebetween unless the term, for example, “right”, “directly”, or “near” is used in the expression.

For the description of a temporal relationship, when a temporal relationship is described as “after,” “subsequently to,” “next,” “before,” and the like, a non-consecutive case may be included unless the term “immediately” or “directly” is used in the expression.

Although the terms “first,” “second,” and the like may be used herein to describe various components, the components are not limited by the terms. These terms are used only to distinguish one component from another. Therefore, a first component described below may be a second component within the technological scope of the present disclosure.

Terms such as first, second, A, B, (a), (b), or the like may be used herein when describing components of the present disclosure. Such terms are used only to distinguish a component from another component, but do not limit the nature, sequence, order, number, or the like of components.

It is to be understood that when a component is described as being “connected,” “coupled,” “linked,” or “attached” to another component, the component may be directly connected, coupled, linked, or attached to the other component, but, unless specifically stated otherwise, still another component may be interposed between these two components so that they are indirectly connected, coupled, linked, or attached.

It is also to be understood that when a component or layer is described as being “in contact with” or “overlapping” another component or layer, the component or layer may be in direct contact with or directly overlapping the other component or layer, but, unless specifically stated otherwise, still another component or layer may be interposed between these two components or layers so that they are in indirect contact with or indirectly overlapping each other.

The term “at least one” should be understood as including any and all combinations of one or more of the associated listed components. For example, the meaning of “at least one of a first component, a second component, and a third component” denotes the combination of all components proposed from two or more of the first component, the second component, and the third component as well as the first component, the second component, or the third component.

The terms “first direction,” “second direction,” “third direction,” “X-axis direction,” “Y-axis direction,” and “Z-axis direction” should not be interpreted as referring only to geometrical relationships that are perpendicular to each other, but may indicate a broader range of directions within the functional scope of the configuration described in the present disclosure.

The features of various implementations of the present disclosure may be partially or entirely combined with each other. The implementations may be technically linked and operate in various ways and may be carried out independently of or in association with each other.

Hereinafter, various implementations of the present disclosure will be described in detail with reference to the accompanying drawings.

In an implementation, the number of defects of sub-pixels is calculated for each predetermined driving option, and it is made possible to determine whether to use the panel based on the minimum number of defects among the calculated driving options. For example, since there is no difference in structure between first light emitting elements or primary light emitting elements (hereinafter referred to as primary light emitting elements) and second light emitting elements or redundancy light emitting elements (hereinafter referred to as redundancy light emitting elements) that constitute a sub-pixel, selecting any light emitting elements may have no effect on the driving of the sub-pixel. However, reflecting only the number of defects of the primary light emitting elements while testing both the primary light emitting elements and the redundancy light emitting elements may lower the process yield. For example, if the number of defects of sub-pixels consisting of the primary light emitting elements and the redundancy light emitting elements exceeds a predetermined threshold during the manufacturing process of the display panel, the panel is not used and discarded. However, since the defect of the display panel is determined only by the number of defects of the primary light emitting elements, the process yield may be lowered.

Therefore, in an implementation, it is intended to calculate the number of defects for a plurality of driving options including not only the number of defects of the primary light emitting elements but also the number of defects of the redundancy light emitting elements.

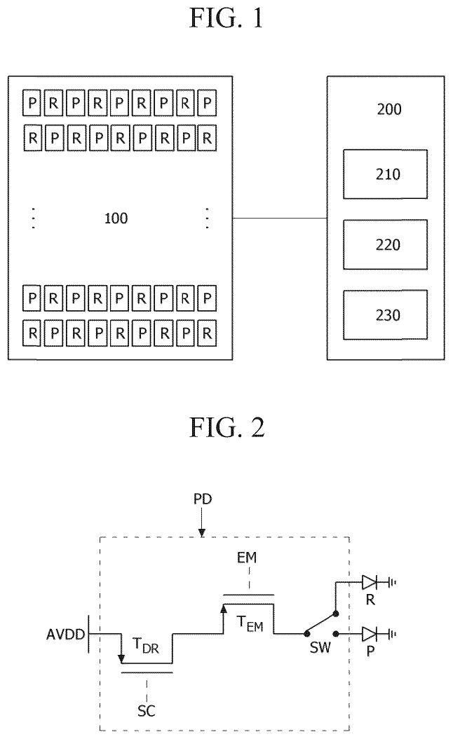

FIG. 1 is a diagram illustrating an inspection apparatus of light emitting elements according to an implementation of the present disclosure, and FIG. 2 is a diagram for explaining the driving principle of primary and redundancy light emitting elements.

Referring to FIGS. 1 and 2, an inspection apparatus 200 of the light emitting elements according to an implementation of the present disclosure may include a display panel 100.

The display panel 100 may include light emitting elements. The light emitting elements may include primary light emitting elements P and redundancy light emitting elements R.

By applying a driving voltage to a pixel driving circuit in the display panel 100, the light emitting elements are illuminated and an image is acquired, and the acquired image is analyzed to detect whether there are defects in the primary light emitting elements and the redundancy light emitting elements arranged for each sub-pixel.

The display panel 100 is just a name used for convenience of explanation, and it is not in a state where the manufacturing process is completed, but in a state where the manufacturing process is in progress, for example, a pixel driving circuit PD is arranged on a substrate, and light emitting elements are transferred on the upper part of the pixel driving circuit PD. However, the present disclosure is not limited thereto.

The inspection apparatus 200 may apply a driving voltage to the pixel driving circuit PD in the display panel 100 to illuminate the light emitting elements, acquire an image, and analyze the acquired image to detect whether there are defects in the primary light emitting elements P and the redundancy light emitting elements R arranged for each sub-pixel of the display panel 100.

The inspection apparatus 200 may include a voltage part 230, an image part 210, and a control part 220, but is not limited thereto.

The voltage part 230 may apply a driving voltage to the pixel driving circuit. The image part 210 may acquire an image of the display panel 100. The control part 220 may calculate the number of defects for each option, determine whether to use the display panel 100, and generate a defect map.

The inspection apparatus 200 may calculate the number of defects for each predetermined driving option based on the detected result, and determine whether to use the display panel 100 based on the calculated number of defects for each driving option.

The inspection apparatus 200 may generate a defect map for changing to redundancy light emitting elements R according to defects of the primary light emitting elements P included in the display panel 100 determined to be used. The defect map thus generated may be stored in an internal memory of a timing controller of the display device and may be used when driving the display device.

Referring to FIG. 2, the pixel driving circuit PD may include switch elements TDR and TEM and a selection switch SW.

Each of the switch elements TDR and TEM may be driven by control signals SC and EM. For example, a high-level power supply voltage AVDD may be applied to a first electrode of the switch element TDR, a first electrode of the switch element TEM may be connected to a second electrode of the switch elements TDR, and a control signal (or scan signal) SC may be applied to a gate electrode of the switch elements TDR. The control signal SC applied to the gate electrode of the switch element TDR may be a direct current (DC) power, and a reference voltage may be applied for each frame, but the implementations of the present disclosure are not limited thereto. The switch element TDR may be a driving transistor, but the implementations of the present disclosure are not limited thereto.

The second electrode of the switch element TDR may be connected to the first electrode of the switch element TEM, a plurality of light emitting elements ED may be connected to the second electrode of the switch element TEM, and the control signal (or emission signal) EM may be applied to the gate electrode of the switch element TEM. The control signal EM applied to the gate electrode of the switch element TEM may be a pulse width modulation signal that varies for each frame, but the implementations of the present disclosure are not limited thereto. The switch element TEM may be a light emitting transistor, but the implementations of the present disclosure are not limited thereto.

The primary light emitting element P and the redundancy light emitting element R may be selectively driven by the selection switch SW of the pixel driving circuit PD based on the defect map. The selection switch SW is connected to and drives the primary light emitting element P, but here it shows a case where the redundancy light emitting element R is connected instead of the primary light emitting element P. However, the present disclosure is not limited thereto.

When the switch elements TDR and TEM of the pixel driving circuit PD are turned on, the primary light emitting element P or the redundancy light emitting element R may be illuminated by the pixel driving voltage AVDD. The primary light emitting element P or the redundancy light emitting element R may be selectively illuminated by the selection switch SW.

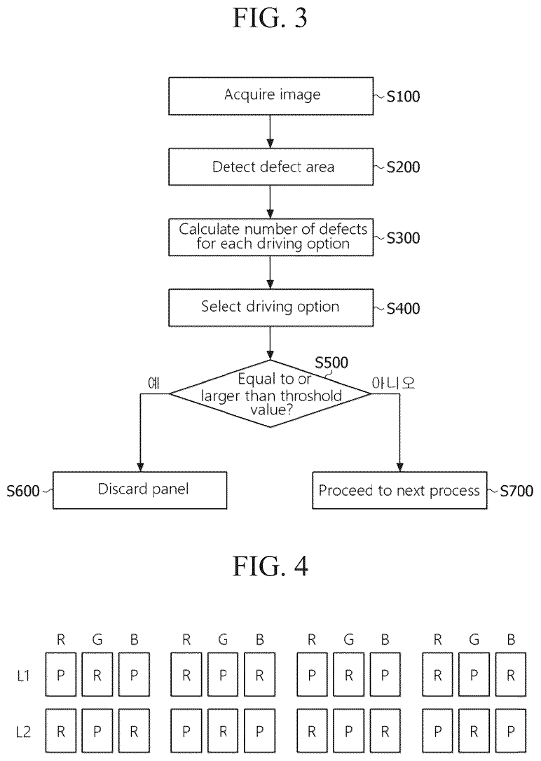

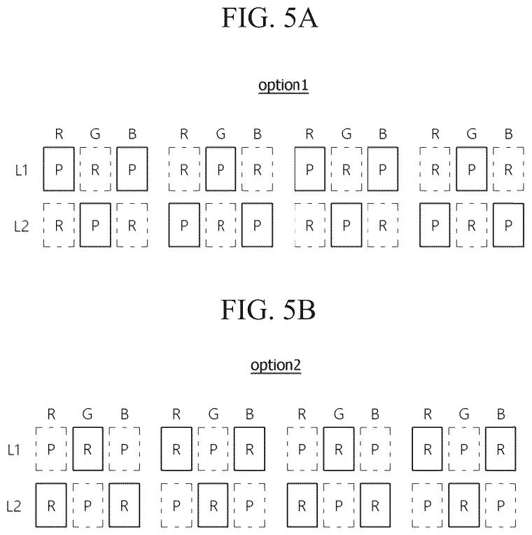

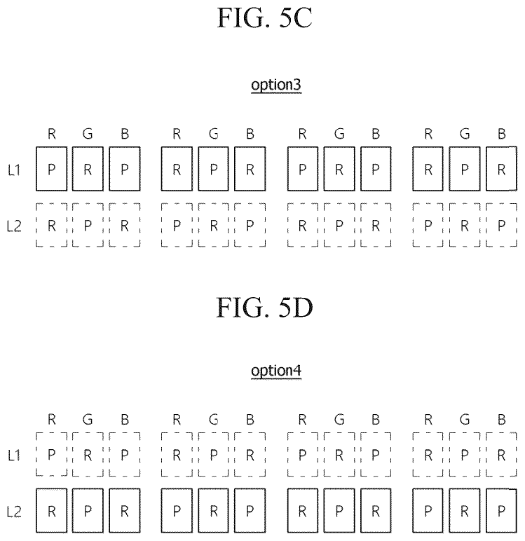

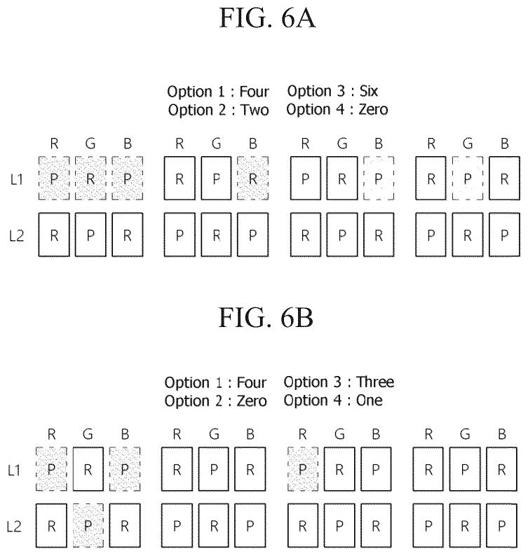

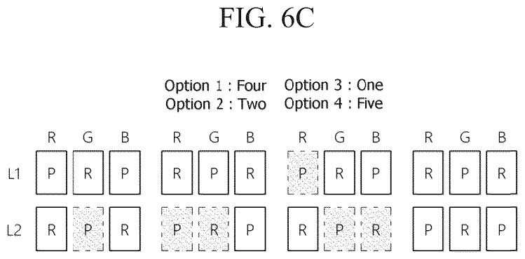

FIG. 3 is a diagram illustrating an inspection method of light emitting elements according to an implementation of the present disclosure. FIG. 4, FIGS. 5A to 5D, and FIGS. 6A to 6C are diagrams for explaining the inspection method shown in FIG. 2.

Referring to FIG. 3, the inspection method of the display device according to an implementation of the present disclosure may apply a driving voltage to the pixel driving circuit to illuminate the light emitting elements and acquire an image (S100).

As shown in FIG. 4, the light emitting elements may include primary light emitting elements P and redundancy light emitting elements R for each color. For example, each light emitting element may consist of a pair of a primary light emitting element P and a redundancy light emitting element R having the same color, but the implementations of the present disclosure are not limited thereto. For example, the light emitting element may include a primary light emitting element P and a redundancy light emitting element R that emit light of a red wavelength, a primary light emitting element P and a redundancy light emitting element R that emit light of a green wavelength, and a primary light emitting element P and a redundancy light emitting element R that emit light of a blue wavelength. However, the present disclosure is not limited thereto.

A primary light emitting element P that emits light of a red wavelength, a redundancy light emitting element R that emits light of a green wavelength, and a primary light emitting element P that emits light of a blue wavelength may be arranged on a first line L1. A redundancy light emitting element R that emits light of a red wavelength, a primary light emitting element P that emits light of a green wavelength, and a redundancy light emitting element R that emits light of a blue wavelength may be arranged on a second line L2. However, the inventive concept is not limited to this arrangement form.

The inspection method may illuminate the light emitting elements according to the driving option to acquire an image. As shown in FIGS. 5A to 5D, the driving option according to an implementation may include a first driving option, a second driving option, a third driving option, and a fourth driving option. Light emitting elements indicated by a solid line may indicate an emitting state, and light emitting elements indicated by a dotted line may indicate a non-emitting state.

According to the first driving option (option1), the inspection apparatus may acquire an image in a state where only the primary light emitting elements P are illuminated and the redundancy light emitting elements are not illuminated, as shown in FIG. 5a.

According to the second driving option (option2), the inspection apparatus may acquire an image in a state where only the redundancy light emitting elements R are illuminated and the primary light emitting elements P are not illuminated, as shown in FIG. 5B.

According to the third driving option (option3), the inspection apparatus may acquire an image in a state where only the light emitting elements arranged on the first line L1 are illuminated and the light emitting elements arranged on the second line L2 are not illuminated, as shown in FIG. 5C.

According to the fourth driving option (option4), the inspection apparatus may acquire an image in a state where only the light emitting elements arranged on the second line L2 is illuminated and the light emitting elements arranged on the first line L1 are not illuminated, as shown in FIG. 5D.

The first to fourth driving options (option1-option4) may vary depending on the arrangement form of the light emitting elements.

Referring to FIG. 3, the inspection method may detect a defect area of the primary light emitting elements P and the redundancy light emitting elements R by analyzing the acquired image (S200), and calculate the number of defects for each driving option based on the detected defect area (S300).

For example, in the first driving option (option1) of FIG. 5A, the number of defects may be calculated based on the defect area where the primary light emitting elements P are not illuminated. In the second driving option (option2) of FIG. 5B, the number of defects may be calculated based on the defect area where the redundancy light emitting elements R are not illuminated. In the third driving option (option3) of FIG. 5C, the number of defects may be calculated based on the defect area where the light emitting elements arranged on the first line L1 are not illuminated. In the fourth driving option (option4) of FIG. 5D, the number of defects may be calculated based on the defect area where the light emitting elements arranged on the second line L2 are not illuminated.

Referring to FIG. 3, the inspection method may select a driving option having a minimum number of defects among the calculated number of defects for each driving option (S400).

Referring to FIGS. 6A to 6C to explain the driving option selection principle according to an implementation, light emitting elements indicated by a solid line may indicate an emitting state, light emitting elements indicated by a dotted line may indicate a non-emitting state, and light emitting elements indicated by hatching may indicate a defect state. For example, the number of defects may include a non-emitting state and a defect state.

For example, as shown in FIG. 6A, the number of defects of the light emitting elements according to the first driving option (option1) may be calculated as 4, the number of defects of the light emitting elements according to the second driving option (option2) may be calculated as 2, the number of defects of the light emitting elements according to the third driving option (option3) may be calculated as 6, and the number of defects of the light emitting elements according to the fourth driving option (option4) may be calculated as 0. Therefore, the option with the minimum number of defects may be the fourth driving option (option4).

As another example, as shown in FIG. 6B, the number of defects of the light emitting elements according to the first driving option (option1) may be calculated as 4, the number of defects of the light emitting elements according to the second driving option (option2) may be calculated as 0, the number of defects of the light emitting elements according to the third driving option (option3) may be calculated as 3, and the number of defects of the light emitting elements according to the fourth driving option (option4) may be calculated as 1. Therefore, the option with the minimum number of defects may be the second driving option (option2).

As another example, as shown in FIG. 6C, the number of defects of the light emitting elements according to the first driving option (option1) may be calculated as 4, the number of defects of the light emitting elements according to the second driving option (option2) may be calculated as 2, the number of defects of the light emitting elements according to the third driving option (option3) may be calculated as 1, and the number of defects of the light emitting elements according to the fourth driving option (option4) may be calculated as 5. Therefore, the option with the minimum number of defects may be the third driving option (option3).

Referring to FIG. 3, the inspection method may compare the number of defects according to the selected driving option with a predetermined threshold value (S500), and the panel in question may be discarded (S600) or proceed to the next process (S700) according to the comparison result.

In FIG. 6A, when the threshold value allowing defects is 3, in an experimental example that applies only the number of defects of the primary light emitting elements P, the condition is not satisfied because the number of defects of the primary light emitting elements P is 4, but in the implementation, the condition may be satisfied because the number of defects of the fourth driving option (option4) is 0.

In FIG. 6B, when the threshold value allowing defects is 3, in an experimental example that applies only the number of defects of the primary light emitting elements P, the condition is not satisfied because the number of defects of the primary light emitting elements P is 4, but in the implementation, the condition may be satisfied because the number of defects of the second driving option (option2) is 0.

In FIG. 6C, when the threshold value allowing defects is 3, in an experimental example that applies only the number of defects of the primary light emitting elements P, the condition is not satisfied because the number of defects of the primary light emitting elements P is 4, but in the implementation, the condition may be satisfied because the number of defects of the third driving option (option3) is 1.

In an implementation of the present disclosure, the display panel 100 may be used not only when the number of defects of the primary light emitting elements P is less than the threshold, but also when it is greater than the threshold but within an acceptable range. Therefore, in the implementation, the display panel 100, which may be discarded if the experimental example applying only the number of defects of the primary light emitting elements P is applied, may be used without being discarded and manufactured as a display device, so that the process yield of the display device may be improved.

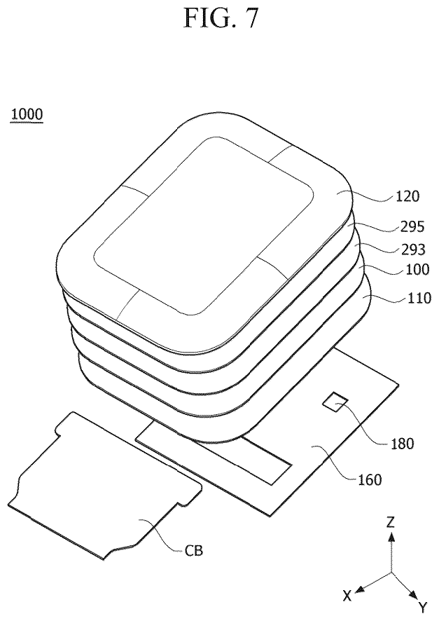

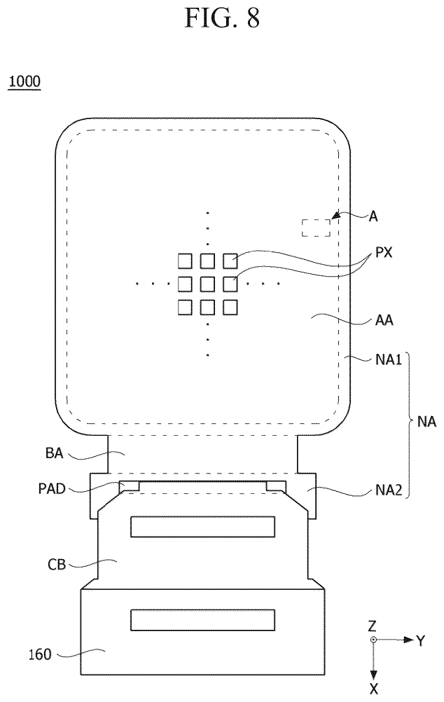

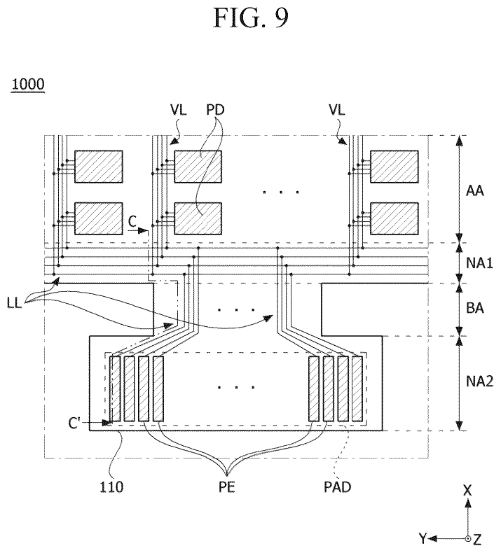

FIG. 7 is an exploded perspective view illustrating a display device according to an implementation of the present disclosure, FIG. 8 is a plan view illustrating a display device according to an implementation of the present disclosure, and FIG. 9 is an enlarged view illustrating a display device according to an implementation of the present disclosure.

Referring to FIGS. 7, 8, and 9, a display device 1000 according to an implementation of the present disclosure may include a display panel 100, a polarizing layer 293, an adhesive layer 295, a cover member 120, a support substrate 110, a flexible circuit board CB, and a printed circuit board 160. However, the implementations of the present disclosure are not limited thereto.

For example, the display device 1000 may include a substrate 110. The substrate 110 may be a member that supports other components of the display device 1000. The substrate 110 may be formed of an insulating material. For example, the substrate 110 may be formed of glass, resin, or the like. In addition, the substrate 110 may be formed of a material that has flexibility. For example, the substrate 110 may be formed of a plastic material having flexibility, such as a polyimide (PI). However, the implementations of the present disclosure are not limited thereto.

The display panel 100 may implement information, videos, and/or images provided to a user. For example, the display panel 100 may include a display area AA and a non-display area NA. The display area AA and the non-display area NA are not limited to the substrate 110 but may be described throughout the entire display device 1000.

The display area AA may be an area in which an image is displayed. The display area AA may include a plurality of pixels PX. Each of the plurality of pixels PX may be composed of a plurality of sub-pixels. A plurality of light-emitting elements may be disposed in each of the plurality of sub-pixels. The plurality of light-emitting elements may be configured differently depending on the type of the display device 1000. For example, when the display device 1000 is an inorganic light-emitting display device, the light-emitting element may be a light-emitting diode (LED), a micro light-emitting diode (micro LED), or a mini light-emitting diode (mini LED), but the implementations of the present disclosure are not limited thereto.

The non-display area NA may be an area in which an image is not displayed. Various lines, circuits, and the like for driving the plurality of pixels PX of the display area AA may be disposed in the non-display area NA. For example, in the non-display area NA, various lines and driving circuits may be mounted, and a pad part PAD to which an integrated circuit, a printed circuit, or the like is connected may be disposed, but the implementations of the present disclosure are not limited thereto.

For example, the driving circuits may be data driving circuits and/or gate driving circuits, but the implementations of the present disclosure are not limited thereto. Lines through which control signals for controlling the driving circuits are supplied may be disposed on the display panel 100. For example, the control signals may include various timing signals such as clock signals, input data enable signals, and synchronization signals, but the implementations of the present disclosure are not limited thereto. The control signals may be received through the pad part PAD. For example, link lines LL for transmitting signals may be disposed in the non-display area NA. For example, driving components such as the flexible circuit board CB and the printed circuit board 160 may be connected to the pad part PAD.

According to the present disclosure, the non-display area NA may include a first non-display area NA1, a bending area BA, and a second non-display area NA2. For example, the first non-display area NA1 may be an area surrounding at least a portion of the display area AA. The bending area BA may be an area extending from at least one of a plurality of sides of the first non-display area NA1, and may be a bendable area. The second non-display area NA2 may be an area extending from the bending area BA, and the pad part PAD may be disposed therein. For example, the bending area BA may be in a bent state, and the remaining area of the substrate 110, excluding the bending area BA, may be in a flat state. In this case, as the bending area BA is bent, the second non-display area NA2 may be located on a rear surface of the display area AA. However, the implementations of the present disclosure are not limited thereto.

The display area AA of the substrate 110 or the display device 1000 may be configured in various shapes depending on the design of the display device 1000. For example, the display area AA may be configured in a rectangular shape with four rounded corners, but the implementations of the present disclosure are not limited thereto. For another example, the display area AA may be configured in a rectangular shape with four right-angled corners, a circular shape, or the like, but the implementations of the present disclosure are not limited thereto.

According to the present disclosure, a width of the second non-display area NA2, in which a plurality of pad electrodes PE are disposed, may be greater than a width of the bending area BA, in which only the plurality of link lines LL are disposed. In addition, a width of the display area AA in which the plurality of sub-pixels are disposed may be greater than the width of the bending area BA in which only the plurality of link lines LL are disposed. In the drawings, the width of the bending area BA is illustrated as being less than that of each of the other areas of the substrate 110, but the shape of the substrate 110 including the bending area BA is an example, and the implementations of the present disclosure are not limited thereto.

Referring to FIG. 9, a plurality of pixel driving circuits PD may be disposed in the display area AA. The plurality of pixel driving circuits PD may be circuits for driving the light-emitting elements of the plurality of sub-pixels. Each of the plurality of pixel driving circuits PD includes a plurality of transistors, including driving transistors, and a storage capacitor, and the like, and the pixel driving circuits PD may supply control signals, power, and driving current to the light-emitting elements of the plurality of sub-pixels, thereby controlling the light-emission operations of the plurality of light-emitting elements. For example, the pixel driving circuit PD may include power lines and signal lines for controlling an on/off state and/or a light-emission time of the light-emitting element. For example, the plurality of pixel driving circuits PD may be driving drivers fabricated using a metal-oxide-silicon field-effect transistor (MOSFET) manufacturing process on a semiconductor s substrate, but the implementations of the present disclosure are not limited thereto. The driving drivers include the plurality of pixel driving circuits PD, and may drive the plurality of sub-pixels.

Referring to FIG. 7 together, the flexible circuit board CB and the printed circuit board 160 may be disposed below the display panel 100. The flexible circuit board CB and the printed circuit board 160 may be disposed at at least one side edge of the display panel 100, but the implementations of the present disclosure are not limited thereto. One side of the flexible circuit board CB may be attached to the display panel 100, and the other side thereof may be attached to the printed circuit board 160, but the implementations of the present disclosure are not limited thereto. The flexible circuit board CB may be a flexible film, but the implementations of the present disclosure are not limited thereto.

The pad part PAD including the plurality of pad electrodes PE may be disposed in the second non-display area NA2. The driving components, including one or more flexible circuit boards (or flexible films) CB and the printed circuit board 160, may be attached or bonded to the pad part PAD. The plurality of pad electrodes PE of the pad part PAD are electrically connected to one or more flexible circuit boards (or flexible films) CB and may transmit various signals (or power) output from the printed circuit board 160 and the flexible circuit boards (or flexible films) CB to the plurality of pixel driving circuits PD in the display area AA.

The flexible circuit board (or flexible film) CB may be a film in which various components are disposed on a base film having flexibility. For example, a driving integrated circuit (IC), such as a gate driver IC or a data driver IC, may be disposed on the flexible circuit board (or flexible film) CB, but the implementations of the present disclosure are not limited thereto. The driving IC may be a component that processes data and driving signals for displaying images. The driving IC may be disposed using methods, such as chip on glass (COG), chip on film (COF), or tape carrier package (TCP), depending on a mounting method, but the implementations of the present disclosure are not limited thereto. The flexible circuit board (or flexible film) CB may be attached or bonded onto the plurality of pad electrodes PE through a conductive adhesive layer, but the implementations of the present disclosure are not limited thereto.

The printed circuit board 160 may be a component that is electrically connected to one or more flexible circuit boards (or flexible films) CB and supplies signals to the driving IC. The printed circuit board 160 is disposed on one side of the flexible circuit board (or flexible film) CB, and may be electrically connected to the flexible circuit board (or flexible film) CB. Various components for supplying various signals to the driving IC may be disposed on the printed circuit board 160. For example, various components, such as a timing controller, a power supply part, a memory, or a processor, may be disposed on the printed circuit board 160. For example, the printed circuit board 160 may include a power management integrated circuit (PMIC), but the implementations of the present disclosure are not limited thereto.

The printed circuit board 160 may include at least one hole 180, but the implementations of the present disclosure are not limited thereto. An internal component configured to detect ambient light or temperature, which may be provided to a plurality of sensors, may be disposed in an area corresponding to the at least one hole 180. For example, the internal component may include an ambient light sensor (ALS), a temperature sensor, or the like, but the implementations of the present disclosure are not limited thereto. For example, the hole 180 may be a through hole or the like, but the implementations of the present disclosure are not limited thereto.

Referring to FIG. 7, the polarizing layer 293 may be disposed on the display panel 100. The polarizing layer 293 may prevent or reduce the light generated from an external light source from entering the display panel 100 and affecting the light-emitting elements or the like.

The cover member 120 may be disposed on the polarizing layer 293. The cover member 120 may be a member for protecting the display panel 100. The adhesive layer 295 may be disposed between the polarizing layer 293 and the cover member 120. The cover member 120 may be attached to the display panel 100 by the adhesive layer 295. The adhesive layer 295 may include an optically clear adhesive (OCA), an optically clear resin (OCR), a pressure-sensitive adhesive (PSA), or the like, but the implementations of the present disclosure are not limited thereto.

The support substrate 110 may be disposed between the display panel 100 and the printed circuit board 160. The support substrate 110 may reinforce the rigidity of the display panel 100. The support substrate 110 may be a back plate, but the implementations of the present disclosure are not limited thereto.

Referring to FIGS. 7, 8, and 9, a plurality of link lines LL may be disposed in the non-display area NA. The plurality of link lines LL may be lines that transmit various signals supplied from one or more flexible circuit boards (or flexible films) CB and the printed circuit board 160 to the display area AA. The plurality of link lines LL may extend from the plurality of pad electrodes PE in the second non-display area NA2 toward the bending area BA and the first non-display area NA1 and may be electrically connected to a plurality of driving lines VL in the display area AA. The plurality of pixel driving circuits PD may be driven by receiving signals from one or more flexible circuit boards (or flexible films) CB and the printed circuit board 160 through the driving lines VL in the display area AA and the link lines LL in the non-display area NA.

For example, the plurality of driving lines VL, along with the plurality of link lines LL, may serve as lines for transmitting signals output from the flexible circuit board (or flexible film) CB and the printed circuit board 160 to the plurality of pixel driving circuits PD. The plurality of driving lines VL may be disposed in the display area AA and electrically connected to the plurality of pixel driving circuits PD, respectively. The plurality of driving lines VL may extend from the display area AA toward the non-display area NA to be electrically connected to the plurality of link lines LL. Accordingly, the signals output from the flexible circuit board (or flexible film) CB and the printed circuit board 160 may be transmitted to each of the plurality of pixel driving circuits PD through the plurality of link lines LL and the plurality of driving lines VL.

As the bending area BA is bent, some of the plurality of link lines LL may also be bent. Stress may be concentrated on a portion of the bent link lines LL, and as a result, cracks may occur in the link lines LL. Accordingly, the plurality of link lines LL may be formed of a conductive material with excellent flexibility to reduce cracks during the bending of the bending area BA. For example, the plurality of link lines LL may be formed of a conductive material with excellent flexibility, such as gold (Au), silver (Ag), or aluminum (Al), but the implementations of the present disclosure are not limited thereto. In addition, the plurality of link lines LL may be formed of one of various conductive materials used in the display area AA. For example, the plurality of link lines LL may be formed of molybdenum (Mo), chromium (Cr), titanium (Ti), nickel (Ni), neodymium (Nd), copper (Cu), an alloy of silver (Ag) and magnesium (Mg), or alloys thereof, but the implementations of the present disclosure are not limited thereto. The plurality of link lines LL may be configured in a multilayer structure including various conductive materials. For example, the plurality of link lines LL may be configured in a triple-layer structure of titanium (Ti)/aluminum (Al)/titanium (Ti), but the implementations of the present disclosure are not limited thereto.

The plurality of link lines LL may be configured in various shapes to reduce stress. At least some of the plurality of link lines LL disposed in the bending area BA may extend in the same direction as an extension direction of the bending area BA, or extend in a direction different from the extension direction of the bending area BA to reduce stress. For example, when the bending area BA extends in one direction from the first non-display area NA1 toward the second non-display area NA2, at least some of the link lines LL disposed in the bending area BA may extend in a direction oblique to the one direction. For another example, at least some of the plurality of link lines LL may be configured in various pattern shapes. For example, at least some of the plurality of link lines LL disposed in the bending area BA may have a conductive pattern repetitively disposed in at least one shape among a diamond shape, a rhombus shape, a trapezoidal wave shape, a triangular wave shape, a sawtooth wave shape, a sine wave shape, a circular shape, and an omega (Ω) shape, but the implementations of the present disclosure are not limited thereto. Accordingly, to minimize the stress concentrated on the plurality of link lines LL and the resulting cracks, the plurality of link lines LL may be formed in various shapes including the above-described shapes, but the implementations of the present disclosure are not limited thereto.

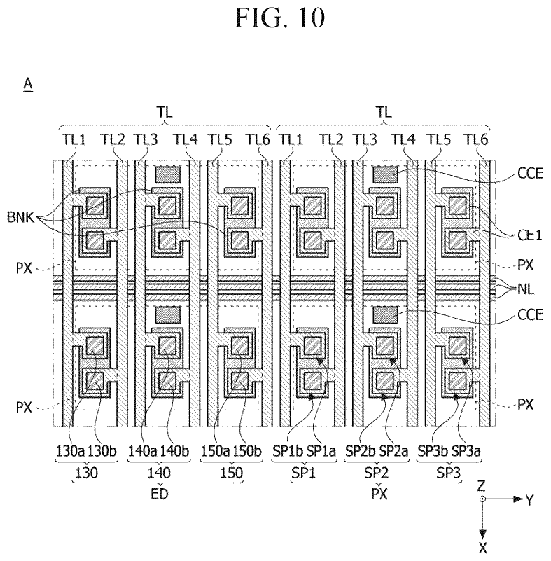

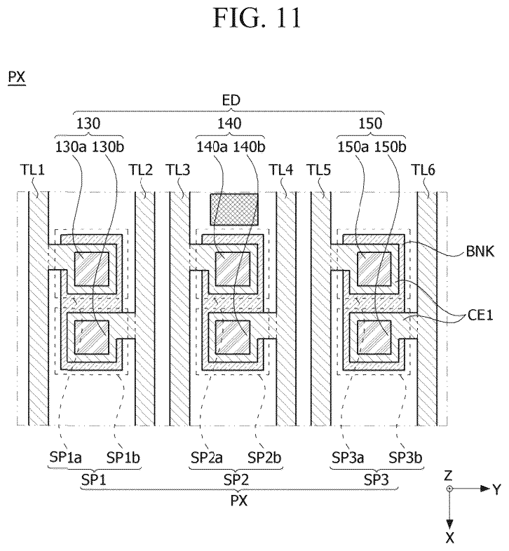

FIGS. 10 to 12 are plan views illustrating the display device according to the implementation of the present disclosure.

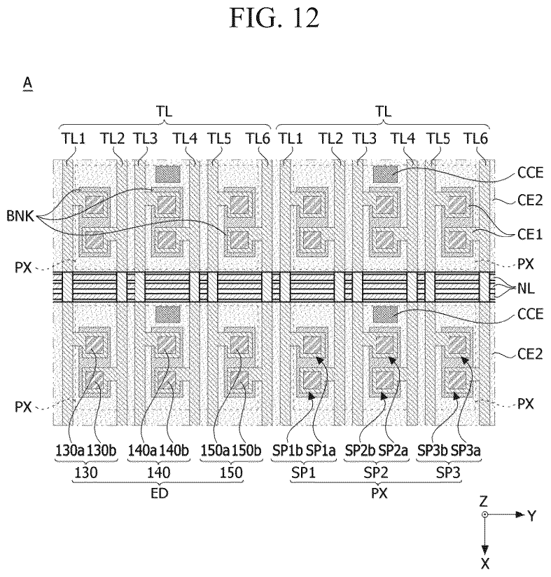

FIGS. 10 and 12 are enlarged views of a display area that includes a plurality of pixels. FIGS. 10 and 12 are partially enlarged views illustrating portion A of FIG. 8.

FIG. 11 is an enlarged view of a display area that includes one pixel. FIG. 11 is a partially enlarged view illustrating one pixel PX.

FIGS. 10 and 11 illustrate only a plurality of signal lines TL, a plurality of communication lines NL, a plurality of first electrodes CE1, a plurality of banks BNK, and a plurality of light-emitting elements ED, but the implementations of the present disclosure are not limited thereto. FIG. 12 is an enlarged plan view of FIG. 10, in which a plurality of second electrodes CE2 are additionally disposed.

Referring to FIGS. 10 and 11, a plurality of pixels PX, each composed of a plurality of sub-pixels, may be disposed in the display area AA. Each of the plurality of sub-pixels includes a light-emitting element ED and may emit light independently. The plurality of sub-pixels may be disposed in a matrix form, forming a plurality of rows and a plurality of columns, but the implementations of the present disclosure are not limited thereto.

The plurality of sub-pixels may include a first sub-pixel SP1, a second sub-pixel SP2, and a third sub-pixel SP3. For example, one of the first sub-pixel SP1, the second sub-pixel SP2, and the third sub-pixel SP3 may be a red sub-pixel, another one thereof may be a green sub-pixel, and the remaining one thereof may be a blue sub-pixel. The types of the plurality of sub-pixels are examples, and the implementations of the present disclosure are not limited thereto.

Each of the plurality of pixels PX may include one or more first sub-pixels SP1, one or more second sub-pixels SP2, and one or more third sub-pixels SP3. For example, one pixel PX may include a pair of first sub-pixels SP1, a pair of second sub-pixels SP2, and a pair of third sub-pixels SP3. The pair of first sub-pixels SP1 may be composed of a 1-1 sub-pixel SP1a and a 1-2 sub-pixel SP1b. The pair of second sub-pixels SP2 may be composed of a 2-1 sub-pixel SP2a and a 2-2 sub-pixel SP2b. The pair of third sub-pixels SP3 may be composed of a 3-1 sub-pixel SP3a and a 3-2 sub-pixel SP3b. For example, one pixel PX may include the 1-1 sub-pixel SP1a, the 1-2 sub-pixel SP1b, the 2-1 sub-pixel SP2a, the 2-2 sub-pixel SP2b, the 3-1 sub-pixel SP3a, and the 3-2 sub-pixel SP3b, but the implementations of the present disclosure are not limited thereto.

The plurality of sub-pixels constituting one pixel PX may be arranged in various ways. For example, in one pixel PX, the pair of first sub-pixels SP1 may be disposed in the same column, the pair of second sub-pixels SP2 may be disposed in the same column, and the pair of third sub-pixels SP3 may be disposed in the same column. The first sub-pixel SP1, the second sub-pixel SP2, and the third sub-pixel SP3 may be disposed in the same row. The number and arrangement of the plurality of sub-pixels constituting one pixel PX are examples, and the implementations of the present disclosure are not limited thereto.

A plurality of signal lines TL may be disposed in areas between the plurality of sub-pixels. The plurality of signal lines TL may extend in a column direction between the plurality of sub-pixels. The plurality of signal lines TL may be lines that transmit an anode voltage output from the pixel driving circuit PD to the plurality of sub-pixels. For example, the plurality of signal lines TL may be electrically connected to the plurality of pixel driving circuits PD and the first electrodes CE1 of the plurality of sub-pixels. The anode voltage output from the pixel driving circuit PD may be transmitted to the first electrodes CE1 of the plurality of sub-pixels through the plurality of signal lines TL. For example, the first electrode CE1 may be an electrode that is electrically connected to an anode 134 of the light-emitting element ED. Thus, the anode voltage transmitted through the signal line TL may be transmitted to the anode 134 of the light-emitting element ED through the first electrode CE1.

Accordingly, the structure of the display device 1000 may be simplified by using the pixel driving circuit PD, in which a plurality of pixel circuits are integrated, instead of forming a plurality of transistors and a storage capacitor in each of the plurality of sub-pixels. In addition, as the circuits disposed in each of the plurality of sub-pixels are integrated into one pixel driving circuit PD, high-efficiency and low-power operation may be enabled.

The plurality of signal lines TL may include a first signal line TL1, a second signal line TL2, a third signal line TL3, a fourth signal line TL4, a fifth signal line TL5, and a sixth signal line TL6. The first signal line TL1 and the second signal line TL2 may be electrically connected to the pair of first sub-pixels SP1, respectively. The third signal line TL3 and the fourth signal line TL4 may be electrically connected to the pair of second sub-pixels SP2, respectively. The fifth signal line TL5 and the sixth signal line TL6 may be electrically connected to the pair of third sub-pixels SP3, respectively.

The first signal line TL1 may be disposed on one side of the pair of first sub-pixels SP1, and the second signal line TL2 may be disposed on the other side of the pair of first sub-pixels SP1. The first signal line TL1 may be electrically connected to the first electrode CE1 of one of the pair of first sub-pixels SP1, for example, the 1-1 sub-pixel SP1a. The second signal line TL2 may be electrically connected to the first electrode CE1 of the other of the pair of first sub-pixels SP1, for example, the 1-2 sub-pixel SP1b.

The third signal line TL3 may be disposed on one side of the pair of second sub-pixels SP2, and the fourth signal line TLA may be disposed on the other side of the pair of second sub-pixels SP2. For example, the third signal line TL3 may be disposed adjacent to the second signal line TL2. The third signal line TL3 may be electrically connected to the first electrode CEL of one of the pair of second sub-pixels SP2, for example, the 2-1 sub-pixel SP2a. The fourth signal line TL4 may be electrically connected to the first electrode CE1 of the other of the pair of second sub-pixels SP2, for example, the 2-2 sub-pixel SP2b.

The fifth signal line TL5 may be disposed on one side of the pair of third sub-pixels SP3, and the sixth signal line TL6 may be disposed on the other side of the pair of third sub-pixels SP3. For example, the fifth signal line TL5 may be disposed adjacent to the fourth signal line TLA. The sixth signal line TL6 may be disposed adjacent to the first signal line TL1 connected to the neighboring pixel PX. The fifth signal line TL5 may be electrically connected to the first electrode CEL of one of the pair of third sub-pixels SP3, for example, the 3-1 sub-pixel SP3a. The sixth signal line TL6 may be electrically connected to the first electrode CE1 of the other of the pair of third sub-pixels SP3, for example, the 3-2 sub-pixel SP3b.

The plurality of signal lines TL may be formed of a conductive material. For example, the plurality of signal lines TL may be formed of a conductive material such as titanium (Ti), aluminum (Al), copper (Cu), molybdenum (Mo), nickel (Ni), chromium (Cr), indium tin oxide (ITO), indium zinc oxide (IZO), or indium gallium zinc oxide (IGZO), but the implementations of the present disclosure are not limited thereto. For another example, the plurality of signal lines TL may be formed in a multilayer structure of conductive materials. For example, the plurality of signal lines TL may be formed in a multilayer structure of titanium (Ti)/aluminum (Al)/titanium (Ti)/indium tin oxide (ITO), but the implementations of the present disclosure are not limited thereto.

The plurality of communication lines NL may be disposed in areas between the plurality of pixels PX. The plurality of communication lines NL may be disposed to extend in a row direction in the areas between the plurality of pixels PX. The plurality of communication lines NL are disposed in areas between the plurality of second electrodes CE2 and may not overlap the plurality of second electrodes CE2. For example, the plurality of communication lines NL may be lines used for short-range communication, such as near-field communication (NFC). The plurality of communication lines NL may function as antennas. For example, the plurality of communication lines NL may be a plurality of connection lines or the like, but the implementations of the present disclosure are not limited thereto.

According to the present disclosure, the bank BNK may be disposed in each of the plurality of sub-pixels. The plurality of banks BNK may be structures on which the plurality of light-emitting elements ED are mounted. The plurality of banks BNK may guide the positions of the plurality of light-emitting elements ED in a transfer process of transferring the plurality of light-emitting elements ED to the display device 1000. In the transfer process of the plurality of light-emitting elements ED, the plurality of light-emitting elements ED may be transferred onto the plurality of banks BNK. The plurality of banks BNKs may be bank patterns or structures or the like, but the implementations of the present disclosure are not limited thereto.

The bank BNK of the first sub-pixel SP1, the bank BNK of the second sub-pixel SP2, and the bank BNK of the third sub-pixel SP3 may be disposed to be spaced apart from each other. The bank BNK of the first sub-pixel SP1, the bank BNK of the second sub-pixel SP2, and the bank BNK of the third sub-pixel SP3 may be configured to be separated from each other. Thus, the banks BNK of the first sub-pixel SP1, the second sub-pixel SP2, and the third sub-pixel SP3, onto which different types of light-emitting elements ED are transferred, may be easily identified.

The bank BNK of the 1-1 sub-pixel SP1a and the bank BNK of the 1-2 sub-pixel SP1b may be connected to each other, or may be spaced apart from each other or separately formed. For example, considering the design requirements of the transfer process and the like, the bank BNK of the 1-1 sub-pixel SP1a and the bank BNK of the 1-2 sub-pixel SP1b, in which the same type of light-emitting elements ED are disposed, may be connected to each other, or may be spaced apart or separated from each other. In addition, the bank BNK of the 2-1 sub-pixel SP2a and the bank BNK of the 2-2 sub-pixel SP2b may be connected to each other, or may be spaced apart from each other or separately formed. The bank BNK of the 3-1 sub-pixel SP3a and the bank BNK of the 3-2 sub-pixel SP3b may be connected to each other, or may be spaced apart from each other or separately formed. Accordingly, the banks BNK of the pair of first sub-pixels SP1, the banks BNK of the pair of second sub-pixels SP2, and the banks BNK of the pair of third sub-pixels SP3 may be variously formed, but the implementations of the present disclosure are not limited thereto.

For example, the plurality of banks BNK may be formed of an organic insulating material. The plurality of banks BNK may be formed of a single layer or multiple layers of an organic insulating material. For example, the plurality of banks BNK may be formed of photoresist, polyimide (PI), or acrylic materials, but the implementations of the present disclosure are not limited thereto.

The first electrode CE1 may be disposed in each of the plurality of sub-pixels. The first electrode CE1 may be disposed on the bank BNK. The first electrode CE1 may be electrically connected to one of the plurality of signal lines TL. At least a portion of the first electrode CE1 may extend outward from the bank BNK to be electrically connected to the signal line TL closest to the first electrode CE1. For example, a portion of the first electrode CE1 of the 1-1 sub-pixel SP1a may extend to one side area of the 1-1 sub-pixel SP1a to be electrically connected to the first signal line TL1, and a portion of the first electrode CE1 of the 1-2 sub-pixel SP1b may extend to the other side area of the 1-2 sub-pixel SP1b to be electrically connected to the second signal line TL2. A portion of the first electrode CE1 of the 2-1 sub-pixel SP2a may extend to one side area of the 2-1 sub-pixel SP2a to be electrically connected to the third signal line TL3, and a portion of the first electrode CE1 of the 2-2 sub-pixel SP2b may extend to the other side area of the 2-2 sub-pixel SP2b to be electrically connected to the fourth signal line TL4. A portion of the first electrode CE1 of the 3-1 sub-pixel SP3a may extend to one side area of the 3-1 sub-pixel SP3a to be electrically connected to the fifth signal line TL5, and a portion of the first electrode CE1 of the 3-2 sub-pixel SP3b may extend to the other side area of the 3-2 sub-pixel SP3b to be electrically connected to the sixth signal line TL6.

The first electrode CE1 may be electrically connected to the anode 134 of the light-emitting element ED, and may transmit the anode voltage output from the pixel driving circuit PD to the light-emitting element ED through the signal line TL. Different voltages may be applied to the first electrode CE1 of each of the plurality of sub-pixels depending on the displayed image. For example, different voltages may be applied to the first electrode CE1 of each of the plurality of sub-pixels. Accordingly, the first electrode CE1 may be a pixel electrode, but the implementations of the present disclosure are not limited thereto.

The first electrode CE1 may be formed of a conductive material. For example, the first electrodes CE1 may be configured integrally with the plurality of signal lines TL. For example, the first electrodes CE1 may be formed of the same conductive material as the plurality of signal lines TL, but the implementations of the present disclosure are not limited thereto. For example, the first electrode CE1 may be formed of a conductive material such as titanium (Ti), aluminum (Al), copper (Cu), molybdenum (Mo), nickel (Ni), chromium (Cr), indium tin oxide (ITO), indium zinc oxide (IZO), or indium gallium zinc oxide (IGZO), but the implementations of the present disclosure are not limited thereto. For another example, the first electrode CE1 may be formed of a multilayer structure of conductive materials. For example, the plurality of first electrodes CE1 may be formed in a multilayer structure of titanium (Ti)/aluminum (Al)/titanium (Ti)/indium tin oxide (ITO), but the implementations of the present disclosure are not limited thereto.

The light-emitting element ED may be disposed in each of the plurality of sub-pixels. Each of the plurality of light-emitting elements ED may be either a light-emitting diode (LED) or a micro light-emitting diode (micro LED), but the implementations of the present disclosure are not limited thereto. The plurality of light-emitting elements ED may be disposed on the banks BNK and the first electrodes CE1. The plurality of light-emitting elements ED may be disposed on the first electrodes CE1, and may be electrically connected to the first electrodes CE1. Thus, the light-emitting element ED may emit light by receiving the anode voltage from the pixel driving circuit PD through the signal line TL and the first electrode CE1.

According to the present disclosure, the light-emitting element ED has been described as having a vertical structure, but the implementations of the present disclosure are not limited thereto. For example, the light-emitting element ED may have a lateral structure or a flip chip structure.

The plurality of light-emitting elements ED may include a first light-emitting element 130, a second light-emitting element 140, and a third light-emitting element 150. The first light-emitting element 130 may be disposed in the first sub-pixel SP1. The second light-emitting element 140 may be disposed in the second sub-pixel SP2. The third light-emitting element 150 may be disposed in the third sub-pixel SP3. For example, one of the first light-emitting element 130, the second light-emitting element 140, and the third light-emitting element 150 may be a red light-emitting element, another one thereof may be a green light-emitting element, and the remaining one thereof may be a blue light-emitting element, but the implementations of the present disclosure are not limited thereto. Accordingly, by combining red light, green light, and blue light emitted from the plurality of light-emitting elements ED, various colors of light, including white, may be implemented. The types of the plurality of light-emitting elements ED are examples, and the implementations of the present disclosure are not limited thereto.

The first light-emitting element 130 may include a 1-1 light-emitting element 130a disposed in the 1-1 sub-pixel SP1a and a 1-2 light-emitting element 130b disposed in the 1-2 sub-pixel SP1b. The second light-emitting element 140 may include a 2-1 light-emitting element 140a disposed in the 2-1 sub-pixel SP2a and a 2-2 light-emitting element 140b disposed in the 2-2 sub-pixel SP2b. The third light-emitting element 150 may include a 3-1 light-emitting element 150a disposed in the 3-1 sub-pixel SP3a and a 3-2 light-emitting element 150b disposed in the 3-2 sub-pixel SP3b.

Referring to FIGS. 10 to 12, the second electrode CE2 may be disposed in each of the plurality of sub-pixels. The second electrode CE2 may be disposed on the light-emitting element ED. The second electrodes CE2 may be electrically connected to the pixel driving circuit PD through a plurality of contact electrodes CCE.

For example, the second electrode CE2 may be electrically connected to a cathode 135 of the light-emitting element ED, and may transmit a cathode voltage output from the pixel driving circuit PD to the light-emitting element ED. The same cathode voltage may be applied to the second electrode CE2 of each of the plurality of sub-pixels. For example, the same voltage may be applied to the second electrodes CE2 of each of the plurality of sub-pixels and the cathode 135 of the light-emitting element ED. Accordingly, the second electrode CE2 may be a common electrode, but the implementations of the present disclosure are not limited thereto.

At least some of the plurality of sub-pixels may share the second electrode CE2. At least some of the second electrodes CE2 of each of the plurality of sub-pixels may be electrically connected to each other. Since the same voltage is applied to the second electrodes CE2, the second electrodes CE2 of at least some of the sub-pixels may be shared. For example, the second electrodes CE2 of at least some of the plurality of pixels PX disposed in the same row may be connected to each other. For example, one second electrode CE2 may be disposed in the plurality of pixels PX. One second electrode CE2 may be disposed for every n sub-pixels.

For example, some of the second electrodes CE2 of each of the plurality of sub-pixels may be spaced apart from each other or separately disposed. For example, the second electrodes CE2 connected to the pixels PX in an nth row and the second electrodes CE2 connected to the pixels PX in a (n+1)th row may be spaced apart from each other or separately disposed. For example, the plurality of second electrodes CE2 may be disposed to be spaced apart from each other with the plurality of communication lines NL extending in the row direction interposed therebetween. Accordingly, the number of sub-pixels may be greater than the number of second electrodes CE2. For another example, all of the second electrodes CE2 of the plurality of sub-pixels may be interconnected so that only one second electrode CE2 is disposed on the substrate 110, but the implementations of the present disclosure are not limited thereto.

The plurality of second electrodes CE2 may be formed of a transparent conductive material, but the implementations of the present disclosure are not limited thereto. The plurality of second electrodes CE2 may be formed of a transparent conductive material so that light emitted from the light-emitting elements ED is directed upward through the second electrodes CE2. For example, the second electrode CE2 may be formed of a transparent conductive material such as indium tin oxide (ITO), indium zinc oxide (IZO), or indium gallium zinc oxide (IGZO), but the implementations of the present disclosure are not limited thereto.

A plurality of contact electrodes CCE may be disposed on the substrate 110. For example, the plurality of contact electrodes CCE may be disposed to be spaced apart from the plurality of banks BNK and the plurality of signal lines TL. Each of the plurality of second electrodes CE2 may overlap at least one contact electrode CCE. For example, one second electrode CE2 may overlap the plurality of contact electrodes CCE.

For example, the plurality of contact electrodes CCE may be electrically connected to the plurality of second electrodes CE2. The plurality of contact electrodes CCE may be disposed between the substrate 110 and the plurality of second electrodes CE2, and may transmit the cathode voltage output from the pixel driving circuit PD to the second electrodes CE2.

For example, when micro LEDs are used as the light-emitting elements ED, a plurality of micro LEDs may be formed on a wafer and transferred onto the substrate 110 of the display device 1000 to manufacture the display device 1000. During the process of transferring the plurality of light-emitting elements ED having a micro size from the wafer to the substrate 110, various defects may occur. For example, in some sub-pixels, a transfer defect may occur in which the light-emitting element ED is not transferred, and in other sub-pixels, a defect may occur in which the light-emitting element ED is transferred out of an intended position due to misalignment. In addition, although the transfer process proceeds normally, the transferred light-emitting element ED itself may be defective. Thus, in consideration of the defects that may occur during the transfer process of the plurality of light-emitting elements ED, the plurality of light-emitting elements ED of the same type may be transferred onto one sub-pixel. A lighting test may be performed on the plurality of light-emitting elements ED, and ultimately, only one light-emitting element ED that is determined to be normal may be used.

For example, the 1-1 light-emitting element 130a and the 1-2 light-emitting element 130b may be transferred together onto one pixel PX, and may be inspected to determine whether there is a defect. When both the 1-1 light-emitting element 130a and the 1-2 light-emitting element 130b are determined to be normal, only the 1-1 light-emitting element 130a may be used, and the 1-2 light-emitting element 130b may not be used. For another example, when only the 1-2 light-emitting element 130b among the 1-1 light-emitting element 130a and the 1-2 light-emitting element 130b is determined to be normal, the 1-1 light-emitting element 130a may not be used, and only the 1-2 light-emitting element 130b may be used. Accordingly, even when the plurality of light-emitting elements ED of the same type are transferred onto one pixel PX, ultimately, only one light-emitting element ED may be used.

Accordingly, one of the pair of light-emitting elements ED may be a main (or primary) light-emitting element ED, and the other one thereof may be a redundancy light-emitting element ED. The redundancy light-emitting element ED may be a spare light-emitting element ED transferred in preparation for a defective main light-emitting element ED. In the event of a defective main light-emitting element ED, the redundancy light-emitting element ED may be used as a replacement. Accordingly, by transferring both the main light-emitting element ED and the redundancy light-emitting element ED onto one pixel PX, the degradation of display quality due to the failure of the main light-emitting element ED or the redundancy light-emitting element ED may be minimized.

For example, the 1-1 light-emitting element 130a, the 2-1 light-emitting element 140a, and the 3-1 light-emitting element 150a transferred onto one pixel PX may be used as main light-emitting elements ED, and the 1-2 light-emitting element 130b, the 2-2 light-emitting element 140b, and the 3-2 light-emitting element 150b transferred onto one pixel PX may be used as redundancy light-emitting elements ED.

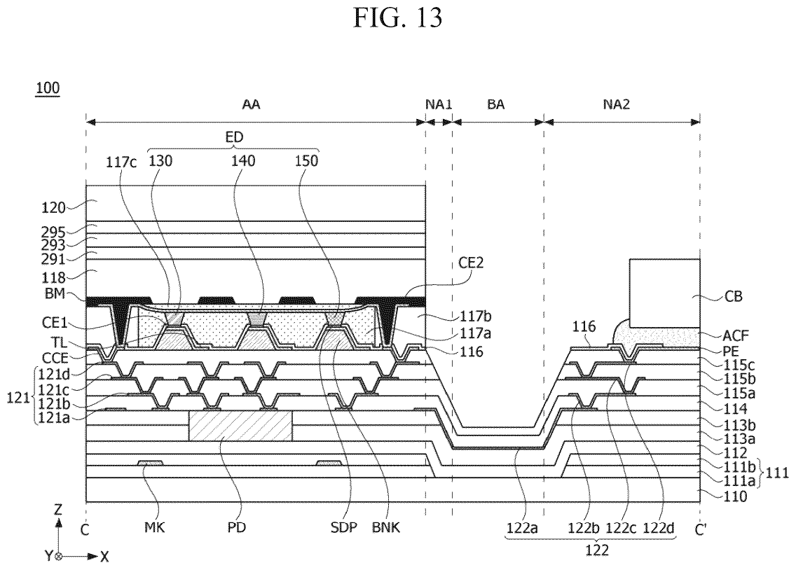

FIG. 13 is a cross-sectional view taken along line C-C′ of FIG. 9.

FIG. 13 is a cross-sectional view of the display area AA, the first non-display area NA1, the bending area BA, and the second non-display area NA2.

Referring to FIG. 13, a first buffer layer 111a and a second buffer layer 111b may be disposed in the remaining area of the substrate 110 excluding the bending area BA.

The first buffer layer 111a and the second buffer layer 111b may be disposed in the display area AA, the first non-display area NA1, and the second non-display area NA2. The first buffer layer 111a and the second buffer layer 111b may reduce the penetration of moisture or impurities through the substrate 110. The first buffer layer 111a and the second buffer layer 111b may be formed of an inorganic insulating material. For example, the first buffer layer 111a and the second buffer layer 111b may each be formed as a single layer or multiple layers of silicon oxide (SiOₓ) or silicon nitride (SiNₓ), but the implementations of the present disclosure are not limited thereto.

For example, some of the first buffer layer 111a and the second buffer layer 111b located in the bending area BA may be removed. An upper surface of the substrate 110 located in the bending area BA may be exposed from the first buffer layer 111a and the second buffer layer 111b. The first buffer layer 111a and the second buffer layer 111b, which are formed of an inorganic insulating material, may be removed from the bending area BA to minimize cracks that may occur in the first buffer layer 111a and the second buffer layer 111b during bending.

A plurality of alignment keys MK may be disposed between the first buffer layer 111a and the second buffer layer 111b. The plurality of alignment keys MK may be configured to identify the position of the pixel driving circuit PD during the manufacturing process of the display device 1000. For example, the plurality of alignment keys MK may be configured to align the position of the pixel driving circuit PD that is transferred onto an adhesive layer 112. For another example, the plurality of alignment keys MK may be omitted.

The adhesive layer 112 may be disposed on the second buffer layer 111b. The adhesive layer 112 may be disposed in the display area AA, the first non-display area NA1, the bending area BA, and the second non-display area NA2. For another example, at least a portion of the adhesive layer 112 may be removed from the non-display area NA including the bending area BA. For example, the adhesive layer 112 may be formed of any one of an adhesive polymer, an epoxy resin, an ultraviolet (UV)-curable resin, a polyimide-based material, an acrylate-based material, a urethane-based material, and polydimethylsiloxane (PDMS), but the implementations of the present disclosure are not limited thereto.

In the display area AA, the pixel driving circuit PD may be disposed on the adhesive layer 112. When the pixel driving circuit PD is implemented as a driving driver, the driving driver may be mounted on the adhesive layer 112 by a transfer process, but the implementations of the present disclosure are not limited thereto.

A first protective layer 113a and a second protective layer 113b may be disposed on the adhesive layer 112 and the pixel driving circuit PD. The first protective layer 113a and the second protective layer 113b may be disposed to surround the side surfaces of the pixel driving circuit PD, but the implementations of the present disclosure are not limited thereto. For example, the second protective layer 113b may be disposed to cover at least a portion of an upper surface of the pixel driving circuit PD. For example, at least one of the first protective layer 113a and the second protective layer 113b disposed in the bending area BA may be omitted. For example, the first protective layer 113a may be entirely disposed in the display area AA and the non-display area NA, and the second protective layer 113b may be partially disposed in the display area AA, the first non-display area NA1, and the second non-display area NA2. For example, a portion of the second protective layer 113b in the bending area BA may be removed. However, the implementations of the present disclosure are not limited thereto.

The first protective layer 113a and the second protective layer 113b may be formed of an organic insulating material, but the implementations of the present disclosure are not limited thereto. For example, the first protective layer 113a and the second protective layer 113b may be formed of photoresist, polyimide (PI), photo acrylic materials, or the like, but the implementations of the present disclosure are not limited thereto. For example, the first protective layer 113a and the second protective layer 113b may each be an overcoating layer or an insulating layer, but the implementations of the present disclosure are not limited thereto.

According to the present disclosure, a plurality of first connection lines 121 may be disposed on the second protective layer 113b in the display area AA. The plurality of first connection lines 121 may be lines for electrically connecting the pixel driving circuit PD to other components. For example, the pixel driving circuit PD may be electrically connected to the plurality of signal lines TL, the plurality of contact electrodes CCE, and the like through the plurality of first connection lines 121. For example, the plurality of first connection lines 121 may include a 1-1 connection line 121a, a 1-2 connection line 121b, a 1-3 connection line 121c, and a 1-4 connection line 121d, but the implementations of the present disclosure are not limited thereto.

For example, a plurality of 1-1 connection lines 121a may be disposed on the second protective layer 113b. The plurality of 1-1 connection lines 121a may be electrically connected to the pixel driving circuit PD. The plurality of 1-1 connection lines 121a may transmit a voltage output from the pixel driving circuit PD to the first electrode CE1 or the second electrode CE2.

For example, a third protective layer 114 may be disposed on the second protective layer 113b. The third protective layer 114 may be entirely disposed in the display area AA and the non-display area NA. In the bending area BA, the third protective layer 114 may cover a side surface of the second protective layer 113b and an upper surface of the first protective layer 113a. The third protective layer 114 may be formed of an organic insulating material. For example, the third protective layer 114 may be formed of photoresist, polyimide (PI), photo acrylic materials, or the like, but the implementations of the present disclosure are not limited thereto. For example, the first protective layer 113a, the second protective layer 113b, and the third protective layer 114 may be formed of the same material, but the implementations of the present disclosure are not limited thereto.

A plurality of 1-2 connection lines 121b may be disposed on the third protective layer 114. The plurality of 1-2 connection lines 121b may be connected to or directly connected to the pixel driving circuit PD. For example, some of the 1-2 connection lines 121b may be directly connected to the pixel driving circuit PD through contact holes of the third protective layer 114. Another part of the 1-2 connection lines 121b may be electrically connected to the 1-1 connection line 121a through contact holes of the third protective layer 114. However, the implementations of the present disclosure are not limited thereto. The voltage output from the pixel driving circuit PD may be transmitted to the first electrode CEL or the second electrode CE2 through the plurality of 1-2 connection lines 121b and other connection lines.

A first insulating layer 115a may be disposed on the plurality of 1-2 connection lines 121b. The first insulating layer 115a may be entirely disposed in the display area AA and the non-display area NA, but the implementations of the present disclosure are not limited thereto. The first insulating layer 115a may be formed of an organic insulating material, but the implementations of the present disclosure are not limited thereto. For example, the first insulating layer 115a may be formed of photoresist, polyimide (PI), a photo acrylic materials, or the like, but the implementations of the present disclosure are not limited thereto.

A plurality of 1-3 connection lines 121c may be disposed on the first insulating layer 115a. The plurality of 1-3 connection lines 121c may be electrically connected to the plurality of 1-2 connection lines 121b. For example, the 1-3 connection lines 121c may be electrically connected to the 1-2 connection lines 121b through contact holes of the first insulating layer 115a.

A second insulating layer 115b may be disposed on the plurality of 1-3 connection lines 121c. The second insulating layer 115b may be disposed in the remaining area excluding the bending area BA, but the implementations of the present disclosure are not limited thereto. The second insulating layer 115b may be disposed in the display area AA, the first non-display area NA1, and the second non-display area NA2, but the implementations of the present disclosure are not limited thereto. For example, a portion of the second insulating layer 115b disposed in the bending area BA may be removed. The second insulating layer 115b may be formed of an organic insulating material, but the implementations of the present disclosure are not limited thereto. For example, the second insulating layer 115b may be formed of photoresist, polyimide (PI), photo acrylic materials, or the like, but the implementations of the present disclosure are not limited thereto.

A plurality of 1-4 connection lines 121d may be disposed on the second insulating layer 115b. The plurality of 1-4 connection lines 121d may be electrically connected to the plurality of 1-3 connection lines 121c. For example, the 1-4 connection lines 121d may be electrically connected to the 1-3 connection lines 121c through contact holes of the second insulating layer 115b.

According to the present disclosure, a plurality of second connection lines 122 may be disposed on the second protective layer 113b in the non-display area NA. The plurality of second connection lines 122 may be lines for transmitting signals, which are transmitted from the flexible circuit board (or flexible film) CB and the printed circuit board 160 (see FIG. 1) to the pad part PAD, to the pixel driving circuit PD of the display area AA. For example, the plurality of second connection lines 122 may be electrically connected to the plurality of pad electrodes PE to receive the signals output from the flexible circuit board (or flexible film) CB and the printed circuit board.

For example, the plurality of second connection lines 122 may extend from the pad part PAD toward the display area AA and may transmit signals to the lines of the display area AA. In this case, the plurality of second connection lines 122 may function as the link lines LL. The plurality of second connection lines 122 may include a 2-1 connection line 122a, a 2-2 connection line 122b, a 2-3 connection line 122c, and a 2-4 connection line 122d.

A plurality of 2-1 connection lines 122a may be disposed on the second protective layer 113b. The plurality of 2-1 connection lines 122a may extend from the second non-display area NA2 to the bending area BA and the first non-display area NA1. The plurality of 2-1 connection lines 122a may transmit signals, which are transmitted to the pad part PAD from the flexible circuit board (or flexible film) CB and the printed circuit board, to the pixel driving circuit PD of the display area AA.

A plurality of 2-2 connection lines 122b may be disposed on the third protective layer 114. The plurality of 2-2 connection lines 122b may be disposed in the second non-display area NA2. The 2-2 connection lines 122b may be electrically connected to the 2-1 connection lines 122a through contact holes of the third protective layer 114. Accordingly, the signals output from the flexible circuit board (or flexible film) CB and the printed circuit board may be transmitted to the 2-1 connection lines 122a through the 2-2 connection lines 122b.

The 2-3 connection line 122c may be disposed on the first insulating layer 115a. The 2-3 connection line 122c may be disposed in the second non-display area NA2. The 2-3 connection line 122c may be electrically connected to the 2-2 connection line 122b through a contact hole of the first insulating layer 115a. Accordingly, the signals output from the flexible circuit board (or flexible film) CB and the printed circuit board may be transmitted to the 2-1 connection lines 122a through the 2-3 connection line 122c and the 2-2 connection lines 122b.

The 2-4 connection line 122d may be disposed on the second insulating layer 115b. The 2-4 connection line 122d may be disposed in the second non-display area NA2. The 2-4 connection line 122d may be electrically connected to the 2-3 connection line 122c through the contact hole of the second insulating layer 115b. Accordingly, the signals output from the flexible circuit board (or flexible film) FF and the printed circuit board may be transmitted to the 2-1 connection lines 122a through the 2-4 connection line 122d, the 2-3 connection line 122c, and the 2-2 connection lines 122b.

The plurality of first connection lines 121 and the plurality of second connection lines 122 may be formed of a highly flexible conductive material or any of the various conductive materials used in the display area AA. For example, the second connection lines 122, some of which are disposed in the bending area BA, may be formed of a highly flexible conductive material such as gold (Au), silver (Ag), or aluminum (Al), but the implementations of the present disclosure are not limited thereto. For another example, the plurality of first connection lines 121 and the plurality of second connection lines 122 may be formed of molybdenum (Mo), chromium (Cr), titanium (Ti), nickel (Ni), neodymium (Nd), copper (Cu), an alloy of silver (Ag) and magnesium (Mg), alloys thereof, or the like, but the implementations of the present disclosure are not limited thereto.

A third insulating layer 115c may be disposed on the plurality of first connection lines 121 and the plurality of second connection lines 122. The third insulating layer 115c may be disposed in the remaining area excluding the bending area BA, but the implementations of the present disclosure are not limited thereto. The third insulating layer 115c may be disposed in the display area AA, the first non-display area NA1, and the second non-display area NA2. A portion of the third insulating layer 115c in the bending area BA may be removed. The third insulating layer 115c may be formed of an organic insulating material, but the implementations of the present disclosure are not limited thereto. For example, the third insulating layer 115c may be formed of photoresist, polyimide (PI), photo acrylic materials, or the like, but the implementations of the present disclosure are not limited thereto.

In the display area AA, a plurality of banks BNK may be disposed on the third insulating layer 115c. The plurality of banks BNK may be disposed to overlap the plurality of sub-pixels, respectively. At least one or more light-emitting elements ED of the same type may be disposed on each of the plurality of banks BNK.

A plurality of signal lines TL may be disposed on the third insulating layer 115c in the display area AA. The plurality of signal lines TL may be disposed in an area between the plurality of banks BNK. For example, the plurality of signal lines TL may be disposed adjacent to any one of the plurality of banks BNK.

A plurality of contact electrodes CCE may be disposed on the third insulating layer 115c in the display area AA. The plurality of contact electrodes CCE may supply a cathode voltage output from the pixel driving circuit PD to the second electrode CE2.

The first electrode CE1 may be disposed on the bank BNK. For example, the first electrode CE1 may be disposed to extend toward an upper portion of the bank BNK from the adjacent signal line TL. The first electrode CE1 may be disposed on upper and side surfaces of the bank BNK. For example, the first electrode CE1 may be disposed to extend from the signal line TL on an upper surface of the third insulating layer 115c to the side and upper surfaces of the bank BNK.

According to the present disclosure, the solder pattern SDP may be disposed on the first electrode CE1 in each of the plurality of sub-pixels. The solder pattern SDP may bond the light-emitting element ED to the first electrode CE1. The first electrode CE1 and the light-emitting element ED may be electrically connected through eutectic bonding using the solder pattern SDP, but the implementations of the present disclosure are not limited thereto. The first electrode CE1 and the anode 134 of the light-emitting element ED may be electrically connected through eutectic bonding using the solder pattern SDP, but the implementations of the present disclosure are not limited thereto. For example, when the solder pattern SDP is formed of indium (In) and the anode 134 of the light-emitting element ED is formed of gold (Au), the solder pattern SDP and the anode 134 may be bonded by applying heat and pressure during the transfer process of the light-emitting element ED. For example, the solder pattern SDP may be formed of indium (In), tin (Sn), or an alloy thereof, but the implementations of the present disclosure are not limited thereto.

The display device may include a plurality of light-emitting elements ED arranged in the display area AA. A passivation layer 116 may be formed to cover banks BNK on which the plurality of light-emitting elements ED are disposed. The passivation layer 116 may include a hole 116bh that exposes the solder pattern SDP. The solder pattern SDP may be a pattern layer, a joining pad, a bonding pad, or the like, but the implementations of the present disclosure are not limited thereto.

The first optical layers 117a surrounding the plurality of light-emitting elements ED in the display area AA may be disposed. For example, the first optical layers 117a may be disposed to cover the plurality of light-emitting elements ED and the banks BNK in the areas of the plurality of sub-pixels. For example, the first optical layers 117a may cover the banks BNK, a portion of the passivation layer 116, and spaces between the plurality of light-emitting elements ED. The first optical layers 117a may be disposed or may cover the spaces between the plurality of light-emitting elements ED included in one pixel PX and between the plurality of banks BNK. For example, the first optical layers 117a may extend in the first direction X and may be disposed spaced apart in the second direction Y. For example, the first optical layer 117a may be disposed to surround the side portions of the light-emitting element ED and the bank BNK between the passivation layer 116 and the second electrode CE2, but the implementations of the present disclosure are not limited thereto. For example, the first optical layer 117a may be a diffusion layer, a sidewall diffusion layer, or the like, but the implementations of the present disclosure are not limited thereto.

The first optical layer 117a may include an organic insulating material in which fine particles are dispersed, but the implementations of the present disclosure are not limited thereto. For example, the first optical layer 117a may be formed of siloxane in which fine metal particles, such as titanium dioxide (TiO₂) particles, are dispersed, but the implementations of the present disclosure are not limited thereto. Light emitted from the plurality of light-emitting elements ED may be scattered by the fine particles dispersed in the first optical layer 117a and emitted to the outside of the display device 1000. Accordingly, the first optical layer 117a may improve the extraction efficiency of the light emitted from the plurality of light-emitting elements ED.

For example, the first optical layer 117a may be disposed in each of the plurality of pixels PX, or the first optical layers 117a may be disposed together with some of the pixels PX disposed in the same row, but the implementations of the present disclosure are not limited thereto. For example, the first optical layer 117a may be disposed in each of the plurality of pixels PX, or the plurality of pixels PX may share one first optical layer 117a. For another example, each of the plurality of sub-pixels may separately include the first optical layer 117a, but the implementations of the present disclosure are not limited thereto.

According to the present disclosure, the second optical layer 117b may be disposed on the passivation layer 116 in the display area AA. For example, the second optical layer 117b may be disposed to surround the first optical layer 117a. For example, the second optical layer 117b may be in contact with a side surface of the first optical layer 117a. For example, the second optical layer 117b may be disposed in areas between the plurality of pixels PX. However, the implementations of the present disclosure are not limited thereto, and for example, the second optical layer 117b may be a diffusion layer, a diffusion layer window, a window diffusion layer, or the like, but the implementations of the present disclosure are not limited thereto.

The second optical layer 117b may be formed of an organic insulating material, but the implementations of the present disclosure are not limited thereto. The second optical layer 117b may be formed of the same material as the first optical layer 117a, but the implementations of the present disclosure are not limited thereto. For example, the first optical layer 117a may include fine particles, and the second optical layer 117b may not include fine particles. For example, the second optical layer 117b may be formed of siloxane, but the implementations of the present disclosure are not limited thereto.

For example, a thickness of the first optical layer 117a may be less than a thickness of the second optical layer 117b, but the implementations of the present disclosure are not limited thereto. Accordingly, when viewed in a plan view, an area in which the first optical layer 117a is disposed may include a recessed portion that is recessed inward relative to an upper surface of the second optical layer 117b.

According to the present disclosure, the second electrode CE2 may be disposed on the first optical layer 117a and the second optical layer 117b. For example, the second electrode CE2 may be electrically connected to the plurality of contact electrodes CCE through a contact hole of the second optical layer 117b. For example, the second electrode CE2 may be disposed on the plurality of light-emitting elements ED. For example, the second electrode CE2 may include a transparent conductive oxide such as indium tin oxide (ITO) or indium zinc oxide (IZO), but the implementations of the present disclosure are not limited thereto. For example, the second electrode CE2 may be disposed to be in contact with the cathode 135. For example, the second electrode CE2 may overlap the first optical layer 117a. For example, the second electrode CE2 may cover a plane on an outer side of the first optical layer 117a.

The second electrode CE2 may continuously extend in the first direction X of the substrate 110. Accordingly, the second electrode CE2 may be commonly connected to the plurality of pixels PX arranged in the first direction X of the substrate 110. For example, the second electrode CE2 may be commonly connected to a plurality of pixels PX.

According to the present disclosure, the second electrode CE2 may continuously extend on the first optical layer 117a, the second optical layer 117b, and the light-emitting element ED. The area in which the first optical layer 117a is disposed may include a recessed portion that is recessed inward relative to the upper surface of the second optical layer 117b. Accordingly, since a first portion of the second electrode CE2 disposed on the first optical layer 117a is disposed along the recessed portion, the first portion of the second electrode CE2 may be disposed at a position lower than that of a second portion of the second electrode CE2 disposed on the second optical layer 117b.

The third optical layer 117c may be disposed on the second electrode CE2. The third optical layer 117c may be disposed to overlap the plurality of light-emitting elements ED and the first optical layer 117a. Since the third optical layer 117c is disposed on the second electrode CE2 and the plurality of light-emitting elements ED, the third optical layer 117c may improve the mura that may occur in some of the plurality of light-emitting elements ED. For example, when transferring the plurality of light-emitting elements ED onto the substrate 110 of the display device 1000, an area in which intervals between the plurality of light-emitting elements ED are not uniform may occur due to process variations or the like. When the intervals between the plurality of light-emitting elements ED are not uniform, light emission areas of each of the plurality of light-emitting elements ED may be disposed unevenly, which may cause a user to perceive mura. Accordingly, by configuring the third optical layer 117c to uniformly diffuse light over the plurality of light-emitting elements ED, the occurrence of light emitted from some light-emitting elements ED appearing as mura can be reduced. Accordingly, the light emitted from the plurality of light-emitting elements ED is evenly diffused by the third optical layer 117c and extracted to the outside of the display device 1000, thereby improving the luminance uniformity of the display device 1000.

The third optical layer 117c may be formed of an organic insulating material in which fine particles are dispersed, but the implementations of the present disclosure are not limited thereto. For example, the third optical layer 117c may be formed of siloxane in which fine metal particles such as titanium dioxide (TiO₂) particles are dispersed, but the implementations of the present disclosure are not limited thereto. For example, the third optical layer 117c may be formed of the same material as the first optical layer 117a, but the implementations of the present disclosure are not limited thereto. For example, the third optical layer 117c may be a diffusion layer, an upper diffusion layer, or the like, but the implementations of the present disclosure are not limited thereto.

According to the present disclosure, light emitted from the plurality of light-emitting elements ED may be scattered by the fine particles dispersed in the third optical layer 117c and emitted to the outside of the display device 1000. The third optical layer 117c may evenly mix the light emitted from the plurality of light-emitting elements ED, thereby further improving the luminance uniformity of the display device 1000. In addition, the light extraction efficiency of the display device 1000 may be improved by the light scattered from the plurality of fine particles, thereby enabling the display device 1000 to operate at lower power.

In the display area AA, the black matrix BM may be disposed on the second electrode CE2, the first optical layer 117a, the second optical layer 117b, and the third optical layer 117c. For example, the contact hole of the second optical layer 117b may be filled with the black matrix BM. The black matrix BM is configured to cover the display area AA, and thus may reduce the color mixing of light from the plurality of sub-pixels and the reflection of external light. For example, the black matrix BM is also disposed in a contact hole in which the second electrode CE2 and the contact electrode CCE are connected, and thus may prevent light leakage between the plurality of adjacent sub-pixels.

For example, the black matrix BM may be formed of an opaque material, but the implementations of the present disclosure are not limited thereto. For example, the black matrix BM may be an organic insulating material containing a black pigment or a black dye, but the implementations of the present disclosure are not limited thereto.

In the display area AA, a cover layer 118 may be disposed on the black matrix BM. The cover layer 118 may protect the configuration below the cover layer 118, and for example, the cover layer 118 may be formed of an organic insulating material, but the implementations of the present disclosure are not limited thereto. For example, the cover layer 118 may be formed of photoresist, polyimide (PI), photo acrylic materials, or the like, but the implementations of the present disclosure are not limited thereto. For example, the cover layer 118 may be an overcoating layer, an insulating layer, or the like, but the implementations of the present disclosure are not limited thereto.

The polarizing layer 293 may be disposed on the cover layer 118 through a first adhesive layer 291. The cover member 120 may be disposed on the polarizing layer 293 through a second adhesive layer 295. For example, the first adhesive layer 291 and the second adhesive layer 295 may include an optically clear adhesive (OCA), optically clear resin (OCR), pressure sensitive adhesive (PSA), or the like, but the implementations of the present disclosure are not limited thereto.

According to the present disclosure, a plurality of pad electrodes PE may be disposed on the third insulating layer 115c in the second non-display area NA2. For example, at least some of the plurality of pad electrodes PE may be exposed from the second passivation layer 116b. For example, the plurality of pad electrodes PE may be electrically connected to the 2-4 connection line 122d through contact holes of the third insulating layer 115c.

An adhesive layer ACF may be disposed on the plurality of pad electrodes PE. The adhesive layer ACF may be an adhesive layer in which conductive balls are dispersed in an insulating material, but the implementations of the present disclosure are not limited thereto. When heat or pressure is applied to the adhesive layer ACF, the conductive balls at the portions to which the heat or pressure is applied may become electrically connected, thereby exhibiting conductive properties. The adhesive layer ACF may be disposed between the plurality of pad electrodes PE and the flexible circuit board (or flexible film) CB, thereby allowing the flexible circuit board (or flexible film) CB to be attached or bonded to the plurality of pad electrodes PE. For example, the adhesive layer ACF may be an anisotropic conductive film (ACF), but the implementations of the present disclosure are not limited thereto.

The flexible circuit board (or flexible film) CB may be disposed on the adhesive layer ACF. The flexible circuit board (or flexible film) CB may be electrically connected to the plurality of pad electrodes PE through the adhesive layer ACF. Accordingly, signals output from the flexible circuit board (or flexible film) CB and the printed circuit board may be transmitted to the pixel driving circuit PD of the display area AA through the plurality of pad electrodes PE, and the 2-4 connection line 122d, the 2-3 connection line 122c, the 2-2 connection line 122b, and the 2-1 connection line 122a.

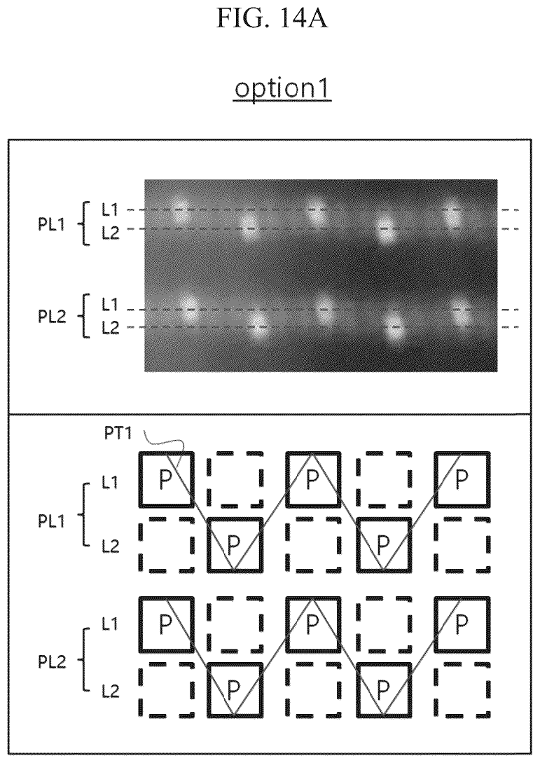

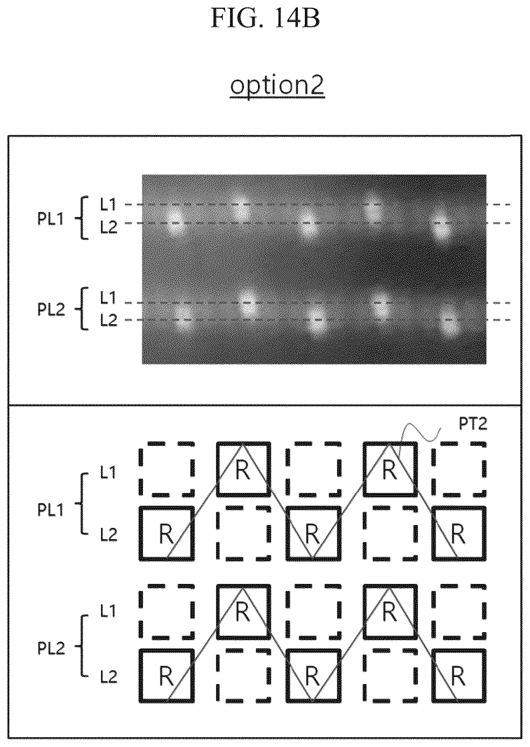

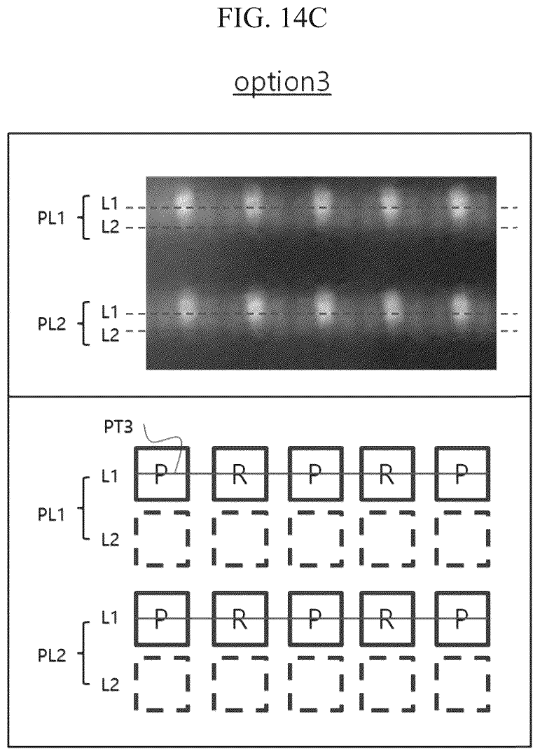

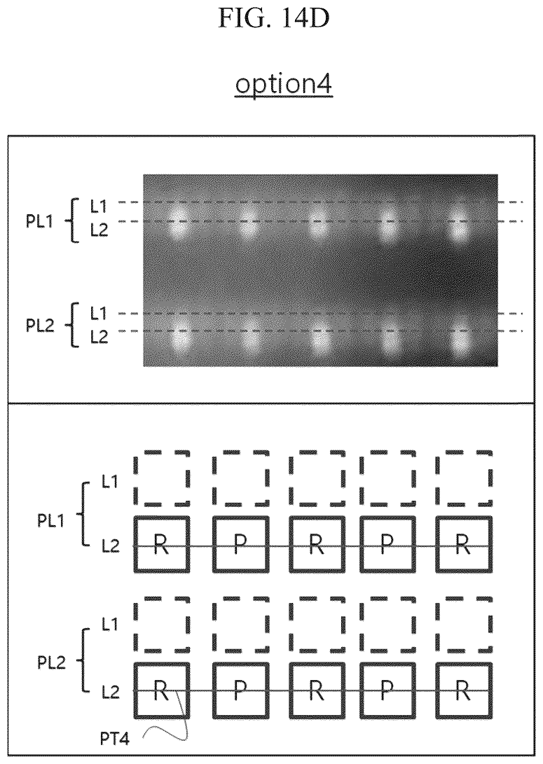

FIGS. 14A to 14D are diagrams for showing the driving state of light emitting elements according to driving options of an implementation. FIGS. 14A to 14D show light emitting elements arranged in two pixel lines PL1 and PL2. Each shows a case of driving the primary light emitting elements P arranged on the first line L1 indicated by a dotted line and the redundancy light emitting elements R arranged on the second line L2 indicated by a dotted line in the first pixel line PL1 and the second pixel line PL2. In the lower part that schematizes the upper part, the light emitting elements indicated by a solid line in a box shape may indicate an emitting state, and light emitting elements indicated by a dotted line in a box shape may indicate a non-emitting state. The red dotted line in the upper part indicates the emitting positions of the light emitting elements of the first line L1 and the second line L2 in each of the first pixel line PL1 and the second pixel line PL2.

Referring to FIGS. 14A to 14D, when the light emitting elements are driven according to the first to fourth driving options of the implementation, a pattern of a specific shape may be shown, and different patterns may be shown for each driving option. However, the present disclosure is not limited thereto.

For example, as shown in FIG. 14A, when only the primary light emitting elements P are driven according to the first driving option (option1), the illuminated primary light emitting elements P may be shown as a first pattern PT1 in a zigzag shape. As shown in FIG. 14B, when only the redundancy light emitting elements R are driven according to the second driving option (option2), the illuminated redundancy light emitting elements R may be shown as a second pattern PT2 in a zigzag shape. As shown in FIG. 14C, when the light emitting elements arranged on the first line L1 is driven according to the third driving option (option3), the light emitting elements illuminated on the first line L1 may be shown as a third pattern PT3 in a straight line shape. As shown in FIG. 14D, when the light emitting elements arranged on the second line L2 are driven according to the fourth driving option (option4), the light emitting elements illuminated on the second line L2 may be shown as a fourth pattern PT4 in a straight line shape.

Therefore, if the inspection is conducted according to the implementation, it may be seen that the patterns shown for each of the first to fourth driving options may be distributed in statistically similar proportions.

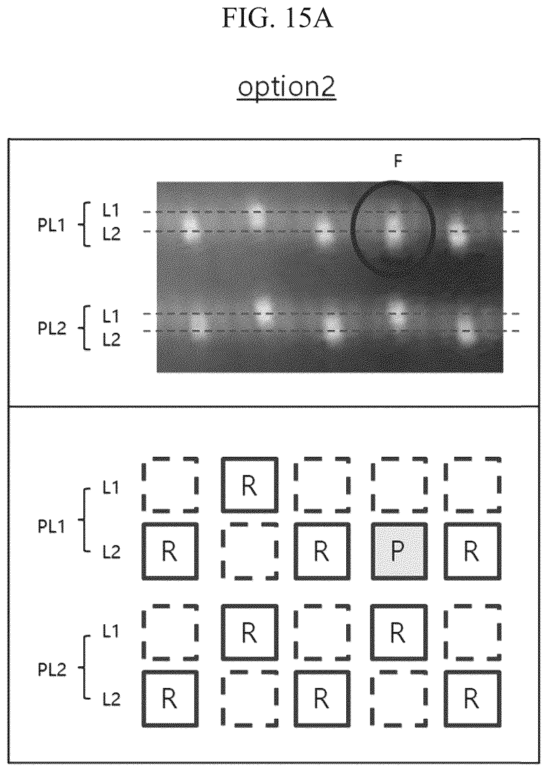

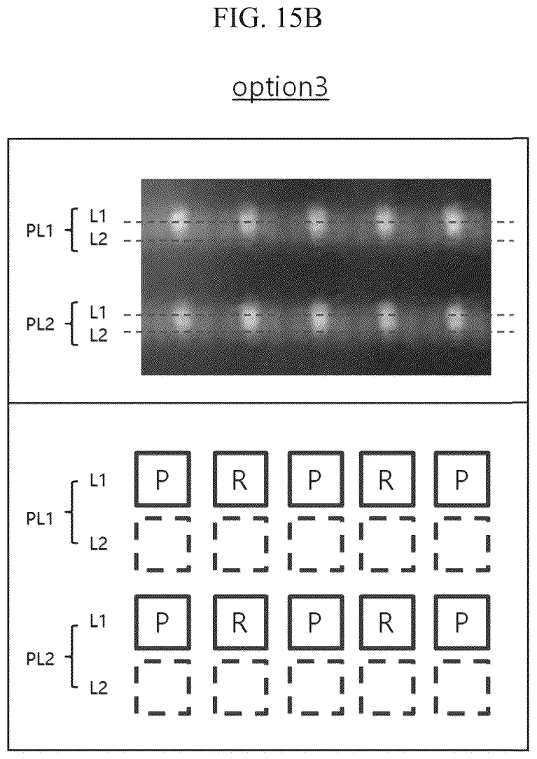

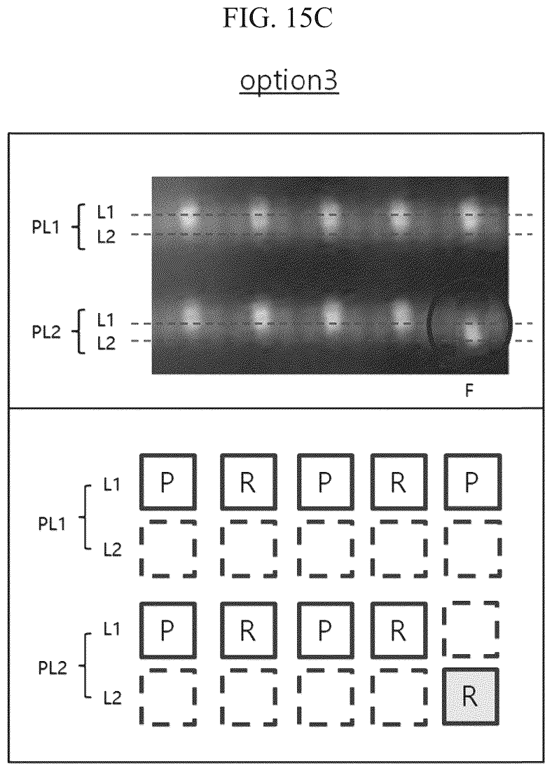

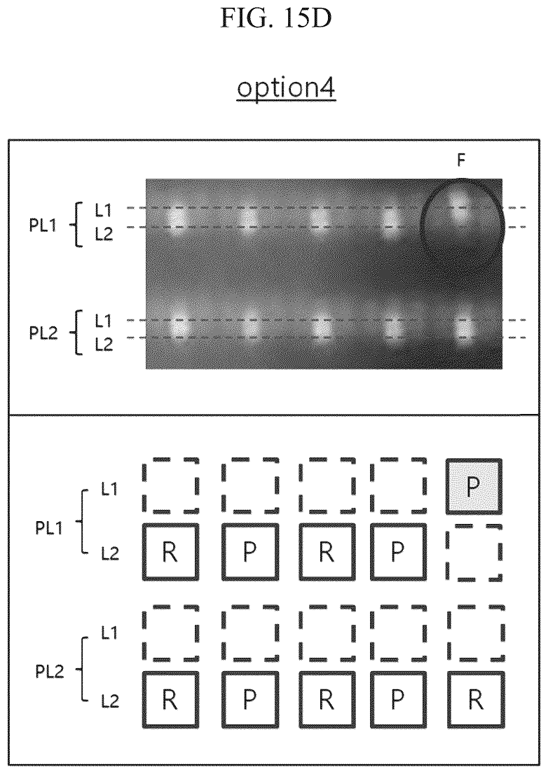

FIGS. 15A to 15D are diagrams for confirming the application of driving options according to an implementation. FIGS. 15A to 15D show light emitting elements arranged in two pixel lines PL1 and PL2. Each shows a case of driving the primary light emitting elements P arranged on the first line L1 indicated by a dotted line and the redundancy light emitting elements R arranged on the second line L2 indicated by a dotted line in the first pixel line PL1 and the second pixel line PL2. In the lower part that schematizes the upper part, a light emitting elements indicated by a solid line in a box shape may indicate an emitting state, and light emitting elements indicated by a dotted line in a box shape may indicate a non-emitting state. The red dotted line in the upper part indicates the emitting positions of the light emitting elements of the first line L1 and the second line L2 in each of the first pixel line PL1 and the second pixel line PL2.

Referring to FIGS. 15A to 15D, when a module with light emitting elements arranged is driven according to the second to fourth driving options excluding the basic first driving option that drives only the primary light emitting elements, it is possible to know whether the driving option according to the implementation is applied through the emission pattern of the light emitting elements.

FIG. 15A shows the illuminated light emitting elements when only the redundancy light emitting elements R are driven in each pixel line PL1, PL2 according to the second driving option (option2). In the sub-pixel arranged in the 4th column F of the first pixel line PL1, the redundancy light emitting elements R of the first line L1 should be driven, but the redundancy light emitting elements R are not driven and the primary light emitting elements P (indicated in blue) of the second line L2 are driven. Therefore, it may be seen that the second driving option (option2) of the implementation is applied to the corresponding panel.

FIG. 15B shows the illuminated light emitting elements when only the light emitting elements of the first line L1 is driven in each pixel line PL1, PL2 according to the third driving option (option3). All light emitting elements of the first line L1 are normally driven. Therefore, it may be seen that the third driving option (option3) of the implementation is applied to the corresponding panel.

FIG. 15C shows the illuminated light emitting elements when only the light emitting elements arranged on the first line L1 are driven in each pixel line PL1, PL2 according to the third driving option (option3). In the sub-pixel arranged in the 5th column F of the second pixel line PL2, the primary light emitting elements P of the first line L1 should be driven, but the primary light emitting elements P are not driven and the redundancy light emitting elements R (indicated in blue) of the second line L2 is driven. Therefore, it may be seen that the third driving option (option3) of the implementation is applied to the corresponding panel.

FIG. 15D shows the illuminated light emitting elements when only the light emitting elements arranged on the second line L2 are driven in each pixel line PL1, PL2 according to the fourth driving option (option4). In the sub-pixel arranged in the 5th column F of the first pixel line PL1, the redundancy light emitting elements R of the second line L2 should be driven, but the redundancy light emitting elements R are not driven and the primary light emitting elements P (indicated in blue) of the first line L1 are driven. Therefore, it may be seen that the fourth driving option (option4) of the implementation is applied to the corresponding panel.

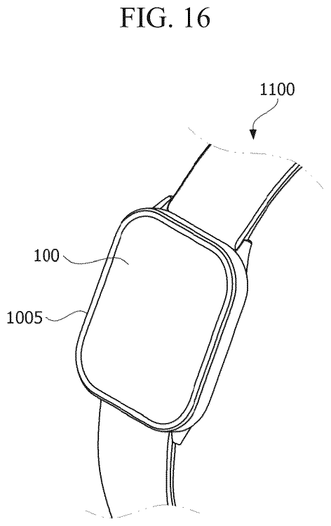

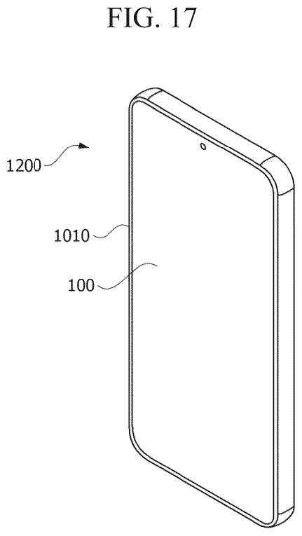

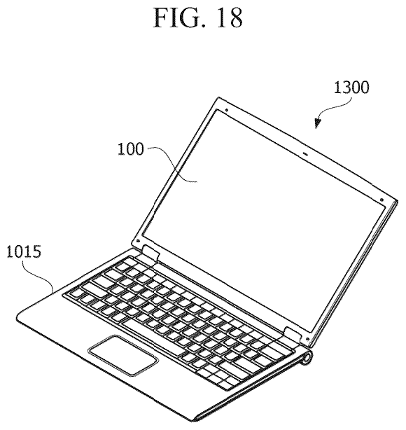

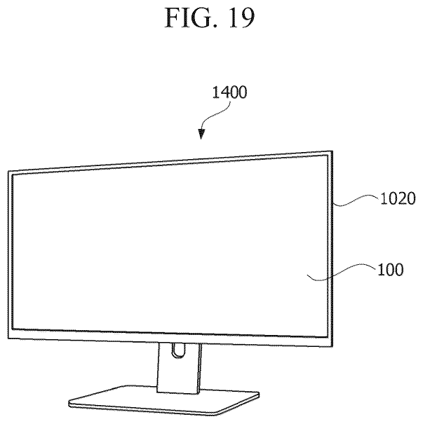

FIGS. 16 to 19 are diagrams illustrating devices to which the display device according to implementations of the present disclosure is applied.

Referring to FIGS. 16 to 19, the display device 1000 according to the implementations of the present disclosure may be included in various devices or electronic devices. For example, referring to FIGS. 32 to 35, the various electronic devices may include a wearable device 1100, a mobile device 1200, a laptop 1300, and a monitor or TV 1400, but the implementations of the present disclosure are not limited thereto.

The wearable device 1100, the mobile device 1200, the laptop 1300, and the monitor or TV 1400 may include case parts 1005, 1010, 1015, and 1020, respectively, and may each include the display panel 100 and the display device 1000 according to the implementations of the present disclosure described above.

For example, the display device according to the implementation of the present disclosure may be applied to mobile devices, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, e-books, portable multimedia players (PMPs), personal digital assistants (PDAs), MP3 players, mobile medical devices, desktop personal computers (PCs) s, laptop PCs, netbook computers, workstations, navigation devices, vehicle display devices, theater display devices, televisions, wallpaper devices, signage devices, gaming devices, laptops, monitors, cameras, camcorders, household appliances, and the like.

The inspection apparatus and an inspection method of light emitting elements according to an implementation of the present disclosure may be described as follows.

An inspection apparatus according to an implementation of the present disclosure may include a collection part configured to acquire an image of first light emitting elements and second light emitting elements arranged in sub-pixels in a display panel according to a plurality of predetermined driving options, and a control part configured to calculate a number of defects for each driving option based on the acquired image, to compare the calculated number of defects for each driving option with a predetermined threshold value, and to determine whether the display panel is a usable normal panel based on a comparison result.

According to one or more implementations of the present disclosure, the plurality of driving options may include a first driving option which illuminates the first light emitting elements to calculate a first number of defects for the first light emitting elements; a second driving option which illuminates the second light emitting elements to calculate a second number of defects for the second light emitting elements; a third driving option which illuminates light emitting elements arranged on a first line to calculate a third number of defects for the light emitting elements arranged on the first line; and a fourth driving option that illuminates light emitting elements arranged on a second line to calculate a fourth number of defects for the light emitting elements arranged on the second line.

According to one or more implementations of the present disclosure, the sub-pixels may include a red sub-pixel, a green sub-pixel, and a blue sub-pixel, the first line may have the first light emitting elements of the red sub-pixel, the second light emitting elements of the green sub-pixel, and the first light emitting elements of the blue sub-pixel arranged, and the second line may have the second light emitting elements of the red sub-pixel, the first light emitting elements of the green sub-pixel, and the second light emitting elements of the blue sub-pixel arranged.

According to one or more implementations of the present disclosure, the control part may determine the display panel to be a usable normal panel when a minimum number of defects among the calculated number of defects for each driving option is less than the predetermined threshold value.

According to one or more implementations of the present disclosure, the control part may generate and store a defect map indicating defect states of the first light emitting elements and the second light emitting elements when the display panel is determined to be a usable normal panel.

An inspection method according to one or more implementations of the present disclosure may include calculating a number of defects for each driving option by driving first light emitting elements and second light emitting elements arranged in sub-pixels in a display panel according to a plurality of predetermined driving options, and determining whether the display panel is a usable normal panel by comparing a calculated number of defects for each driving option with a predetermined threshold value.

According to one or more implementations of the present disclosure, said calculating may include acquiring an image by driving the first light emitting elements and the second light emitting elements according to the plurality of driving options; and calculating the number of defects for each driving option based on the acquired image.

According to one or more implementations of the present disclosure, said determining may include determining the display panel to be a usable normal panel when a minimum number of defects among the calculated number of defects for each driving option is less than the predetermined threshold value.

According to one or more implementations of the present disclosure, may further include generating a defect map indicating defect states of the first light emitting elements and the second light emitting elements when the display panel is determined to be a usable normal panel.

While the implementations of the present disclosure have been described in detail above with reference to the accompanying drawings, the present disclosure is not necessarily limited to these implementations, and various changes and modifications may be made without departing from the technical spirit of the present disclosure.

Accordingly, the implementations disclosed herein are to be considered descriptive and not restrictive of the technical spirit of the present disclosure, and the scope of the technical spirit of the present disclosure is not limited by these implementations.

Accordingly, the above-described implementations should be understood to be examples and not limiting in any aspect.

The scope of the present disclosure should be construed by the appended claims, and all technical ideas within the scope of their equivalents should be construed as being included in the scope of the present disclosure.

What is claimed is:

1. An inspection apparatus comprising:
a collection part configured to acquire, according to a plurality of predetermined driving options, an image of first light emitting elements and second light emitting elements arranged in sub-pixels in a display panel; and
a control part configured to calculate a number of defects for each driving option based on the acquired image, to compare the calculated number of defects for each driving option with a predetermined threshold value, and to determine whether the display panel is a usable normal panel based on a comparison result.

2. The inspection apparatus according to claim 1, wherein the plurality of predetermined driving options include:
a first driving option which illuminates the first light emitting elements to calculate a first number of defects for the first light emitting elements;
a second driving option which illuminates the second light emitting elements to calculate a second number of defects for the second light emitting elements;
a third driving option which illuminates light emitting elements arranged on a first line to calculate a third number of defects for the light emitting elements arranged on the first line; and
a fourth driving option that illuminates light emitting elements arranged on a second line to calculate a fourth number of defects for the light emitting elements arranged on the second line.

3. The inspection apparatus according to claim 2, wherein:
the sub-pixels include a red sub-pixel, a green sub-pixel, and a blue sub-pixel,
the first line has the first light emitting elements of the red sub-pixel, the second light emitting elements of the green sub-pixel, and the first light emitting elements of the blue sub-pixel arranged, and
the second line has the second light emitting elements of the red sub-pixel, the first light emitting elements of the green sub-pixel, and the second light emitting elements of the blue sub-pixel arranged.

4. The inspection apparatus according to claim 1, wherein the control part is configured to determine the display panel to be a usable normal panel when a minimum number of defects among the calculated number of defects for each driving option is less than the predetermined threshold value.

5. The inspection apparatus according to claim 1, wherein the control part is configured to generate and store a defect map indicating defect states of the first light emitting elements and the second light emitting elements when the display panel is determined to be a usable normal panel.

6. An inspection method comprising:
calculating a number of defects for each driving option by driving, according to a plurality of predetermined driving options, first light emitting elements and second light emitting elements arranged in sub-pixels in a display panel; and
determining whether the display panel is a usable normal panel by comparing a calculated number of defects for each driving option with a predetermined threshold value.

7. The inspection method according to claim 6, wherein the plurality of predetermined driving options include:
a first driving option that illuminates the first light emitting elements to calculate a first number of defects for the first light emitting elements;
a second driving option that illuminates the second light emitting elements to calculate second number of defects for the second light emitting elements;
a third driving option that illuminates light emitting elements arranged on a first line to calculate a third number of defects for the light emitting elements arranged on the first line; and
a fourth driving option that illuminates light emitting elements arranged on a second line to calculate a fourth number of defects for the light emitting elements arranged on the second line.

8. The inspection method according to claim 7, wherein:
the sub-pixel includes a red sub-pixel, a green sub-pixel, and a blue sub-pixel,
the first line has the first light emitting elements of the red sub-pixel, the second light emitting elements of the green sub-pixel, and the first light emitting elements of the blue sub-pixel arranged, and
the second line has the second light emitting elements of the red sub-pixel, the first light emitting elements of the green sub-pixel, and the second light emitting elements of the blue sub-pixel arranged.

9. The inspection method according to claim 6, wherein said calculating includes:
acquiring an image by driving the first light emitting elements and the second light emitting elements according to the plurality of predetermined driving options; and
calculating the number of defects for each driving option based on the acquired image.

10. The inspection method according to claim 6, wherein said determining includes:
determining the display panel to be a usable normal panel when a minimum number of defects among the calculated number of defects for each driving option is less than the predetermined threshold value.

11. The inspection method according to claim 6, further comprising:
generating a defect map indicating defect states of the first light emitting elements and the second light emitting elements when the display panel is determined to be a usable normal panel.
